(19) United States
(12) Patent Application Publication
(10) Pub. No.: US 2026/0044789 A1
(43) Pub. Date: Feb. 12, 2026

(54) METHOD AND SYSTEM FOR OPTIMALLY GUIDING CUSTOMERS TO SEATS BASED ON PREDICTED CONSUMPTION AND RESTAURANT ENVIRONMENT

(71) Applicant: Kura Sushi, Inc., Osaka (JP)

(72) Inventor: Kunihiko TANAKA, Osaka (JP)

(21) Appl. No.: 19/362,453

(22) Filed: Oct. 19, 2025

Related U.S. Application Data
(63) Continuation of application No. PCT/JP2024/017748, filed on May 14, 2024.

(30) Foreign Application Priority Data
Jul. 11, 2023 (JP) 2023-113614

(51) Int. Cl. G06Q 10/02; G06Q 50/12

(52) U.S. Cl. CPC G06Q 10/028; G06Q 50/12

(57) ABSTRACT

A display system for optimally guiding customers to seats in a restaurant includes an information processing device and a display device displaying an image to a staff of the restaurant. When there are two or more seat groups as candidate destinations for guiding a user who has visited the restaurant, the information processing device calculates scores for the two or more seat groups as the load information and transmit the scores to the display device. The display device displays the scores in association with the two or more seat groups upon receiving the scores.

### CROSS REFERENCE TO RELATED APPLICATION

This application is a continuation application of International Patent Application No. PCT/JP2024/017748 filed on May 14, 2024, which designated the U.S. and claims the benefit of priority from Japanese Patent Application No. 2023-113614 filed on July 11, 2023. The entire disclosure of the above application is incorporated herein by reference.

### TECHNICAL FIELD

The present disclosure relates to a method and system for optimally guiding customers to seats.

### BACKGROUND

Patent Document 1 (JP 2007-275454 A) describes a food conveyance device for restaurants in which food information associated with food items ordered by a customer is stored in association with the customer’s personal information. When the same customer dines again, the food information associated with the customer is displayed in the kitchen.

Patent Document 2 (JP 2002-189788 A) describes an electronic ordering system that includes an order input device into which a customer inputs order items, and an order output device that outputs the customer’s ordered items sent from the order input device, in order to allow customers to place orders easily and reliably while reducing labor costs for the restaurant. In this system, orders from the order input device are sent to the order output device, and by being output from there, customers can easily place orders without the need for staff to take the orders.

Patent Document 3 (JP 2000-105784 A) describes a shopping display system configured to provide product information tailored to the individual characteristics of users. Based on the user's purchase history, the system selects unpurchased products within the same stage or level and presents compelling product recommendations.

### SUMMARY

If it becomes possible to predict the next consumption behavior by a user who utilizes a restaurant store, it will be useful in that the restaurant operation can be carried out more efficiently and, consequently, a better user experience can be provided.

Accordingly, the present disclosure aims to provide a method and system for optimally guiding customers to seats based on usage information and the conditions of the restaurant.

A first aspect of the present disclosure is a method for optimally guiding customers to seats. The method, executed by a processor of an information processing device in a restaurant, includes: storing usage information in a user information storage unit in association with a user identifier identifying a user, the usage information relating to use of the restaurant by the user and including past usage information relating to consumption behavior by the user in a past usage opportunity; acquiring, based on the usage information acquired from the user information storage unit, prediction information including a prediction result of the consumption behavior by the user who has visited the restaurant; acquiring status information indicating a busyness level of the restaurant based at least on a number of users in the restaurant; acquiring, as support information usable for operation of the restaurant, seat guidance information for guiding the user who has visited the restaurant to a seat in the restaurant based on the prediction information of the user who has visited the restaurant and the status information of the restaurant; and outputting the seat guidance information to a notification device used for guiding the user who has visited the restaurant to the seat.

According to this method, seat guidance information is obtained based on the prediction information and the status information. The seat guidance information is output to the notification device and notified to guide the user to the predetermined seat. Therefore, it becomes possible to guide the user to the optimal seat considering both the prediction information for the visiting user and the restaurant status at that time. As a result, the restaurant can be operated efficiently, and suitable services can be provided to the user.

In a second aspect of the method, the seat guidance information is acquired such that positions of users dining in the restaurant are dispersed when a predetermined time has elapsed.

According to the above-described method, since the seat guidance information is obtained so that the positions of users dining in the restaurant are dispersed, users can enjoy their meals comfortably.

In a third aspect of the method, the restaurant has two or more seat groups each having two or more seats, and the seat guidance information is acquired such that a particular seat group among the two or more seat groups becomes vacant when a predetermined time has elapsed.

According to the above-described method, for example, in cases where the use of a specific seat group is suspended during a time period in which relatively few customers are expected, it becomes possible to suspend the use of the specific seat group at an appropriate timing. Also, users who reserve seats for a specific future time can reliably use those seats, making restaurant operation more effective.

In a fourth aspect of the method, the restaurant has two or more seat groups each having two or more seats, the seat guidance information is acquired based further on load information relating to a load for operating the restaurant, and the load information is acquired based on at least one of a quantity of orders of food items, an order frequency, a future usage rate of each of the two or more seat groups, and a number of events requiring involvement of a staff of the restaurant.

According to the above-described method, since the seat guidance information is further obtained based on the load information related to the operational load on the restaurant, the seat guidance information can be appropriately obtained according to the restaurant's operational load. As a result, it is possible to provide efficient restaurant operation considering operational load.

In a fifth aspect of the method, the method further includes, when there are two or more seat groups as candidate destinations for guiding a user who has visited the restaurant, acquiring scores for the two or more seat groups as the load information, wherein each of the scores indicates a load that is assumed if the user is guided to a corresponding seat group of the two or more seat groups, and the seat guidance information is acquired such that the user who has visited the restaurant is guided to one of the two or more seat groups having a smallest score of the scores.

According to the above-described method, by obtaining a score indicating the load as the load information and acquiring seat guidance information so that the user is guided to the seat group with the smallest score, the restaurant can be operated in the least burdensome manner and therefore it can be run efficiently.

In a sixth aspect of the method, the notification device includes a staff notification device that notifies a staff of the restaurant, and the method further includes outputting the scores to the staff notification device such that the staff notification device notifies the staff of the scores in association with the corresponding two or more seat groups.

According to the above-described method, the score for each seat group is notified to the staff via the staff notification device. Therefore, the staff can flexibly determine the seat to guide the user based on the restaurant load inferred from each seat group’s score.

A seventh aspect of the information processing device according to the present disclosure includes: a user information storage unit storing, in association with a user identifier identifying a user, usage information relating to use of a restaurant by the user, the usage information including past usage information relating to consumption behavior by the user in a past usage opportunity; a prediction unit acquiring prediction information including a prediction result of next consumption behavior by the user based on the usage information acquired from the user information storage unit; a status information acquisition unit acquiring status information relating to a status in the restaurant; a support information acquisition unit acquiring, based on the prediction information acquired by the prediction unit for the user who has visited the restaurant and the status information of the restaurant, support information usable for operation of the restaurant; and a support information output unit outputting the support information.

With this configuration, the next consumption behavior of a user utilizing a restaurant can be predicted based on usage information related to consumption behavior during past usage.

In an eighth aspect of the information processing device, a consumption information acquisition unit acquiring consumption information relating to a current consumption behavior by the user who has visited the restaurant, wherein the consumption information acquisition unit is further configured to accumulate the acquired consumption information as the past usage information in the user information storage unit in association with the user identifier identifying the user.

With this configuration, it becomes possible to predict the user's next consumption behavior with higher accuracy based on information related to the user's current consumption behavior.

In a ninth aspect of the information processing device, the usage information includes next usage information that is relating to a planned future use and is input by a user who plans to use the restaurant.

With this configuration, the user's next consumption behavior can be predicted with higher accuracy based on information related to the planned future visit.

In a tenth aspect of the information processing device, the prediction unit is further configured to acquire the prediction information including a prediction result of the next consumption behavior by a group including two or more users based on the usage information of a user in the group and number-of-persons information of the group.

With this configuration, in the case of a group visit, prediction information can be obtained based on the number of people visiting the restaurant.

In an eleventh aspect of the information processing device, the prediction unit is further configured to acquire the prediction information including a prediction result of the next consumption behavior by a group including two or more users based on the usage information of each of the two or more users in the group, and the usage information includes group information relating to the group including the user in a past usage opportunity and past usage information relating to consumption behavior by the group.

With this configuration, in the case of a group visit, prediction information can be obtained with higher accuracy.

In a twelfth aspect of the information processing device, the device further includes a seat information acquisition unit acquiring seat information including information identifying a seat assigned for a user who has visited the restaurant, wherein the seat information acquisition unit is further configured to accumulate the acquired seat information in the user information storage unit in association with the user identifier identifying the user.

With this configuration, prediction information for a user using each seat can be output for each seat.

In a thirteenth aspect of the information processing device, the device further includes a target behavior information acquisition unit acquiring target behavior information relating to a predetermined record target behavior which is a behavior currently conducted by a user who has visited the restaurant and is different from the consumption behavior, wherein the target behavior information acquisition unit is further configured to accumulate the acquired target behavior information as the usage information in the user information storage unit in association with the user identifier identifying the user.

With this configuration, prediction information can be output using a particular record target behavior different from consumption behavior.

In a fourteenth aspect of the information processing device, the prediction unit is further configured to acquire the prediction information including a prediction result of a future consumption behavior by the user during a current usage opportunity based on the usage information relating to past consumption behavior by the user in a past usage opportunity and the usage information relating to past consumption behavior by the user during the current usage opportunity.

With this configuration, prediction information regarding future consumption behavior during the current usage opportunity can be output based on the current usage opportunity’s information.

In a fifteenth aspect of the information processing device, the restaurant has two or more seat groups each having two or more seats, the support information acquisition unit is further configured to: acquire, based on the prediction information acquired by the prediction unit for the user who has visited the restaurant and the status information of the restaurant, load information relating to a load for operating the restaurant for each of the two or more seat groups; and acquire the support information based on the load information.

With this configuration, support information based on load information related to restaurant operation for each seat group can be output.

In a sixteenth aspect of the information processing device, the support information acquisition unit acquires, as the support information, seat guidance information relating to a seat for guiding the user who has visited the restaurant.

With this configuration, seat guidance information for guiding the user who visited the restaurant can be output.

In a seventeenth aspect of the information processing device, the support information output unit is configured to cause an output device corresponding to the seat for guiding the user who has visited the restaurant to output information indicating a number of users in a group including the user.

With this configuration, by outputting the information indicating the number of users in the group including the user in a manner corresponding to the seat to which the user visiting the restaurant is guided, preparations according to the number of users of the group including the user can be easily made by the staff, enabling smooth restaurant operation.

In an eighteenth aspect of the information processing device, the device further includes a future status information acquisition unit acquiring, using the prediction information acquired for users currently using the restaurant and the prediction information acquired for users who will use the restaurant in the future, future status information relating to a future status in the restaurant; and a future status information output unit outputting the future status information such that a staff of the restaurant can confirm the future status information.

With this configuration, staff can perform their duties while easily recognizing the predicted future status of the restaurant.

According to the information processing device and the like in the present disclosure, the next consumption behavior of a user utilizing a restaurant can be predicted based on usage information.

### BRIEF DESCRIPTION OF DRAWING

FIG. 1 is a diagram explaining an example of a conveyance device and other equipment used in a restaurant where a restaurant system according to an embodiment is implemented.

FIG. 2 is a plan view showing an overview of the restaurant system.

FIG. 3 is another plan view showing an overview of the restaurant system.

FIG. 4 is a diagram showing a block configuration of the restaurant system.

FIG. 5 is a diagram showing an example of user information used by the information processing device.

FIG. 6 is a flowchart showing an example of the operation of the information processing device.

FIG. 7 is a flowchart showing an example of a usage information update process performed by the information processing device.

FIG. 8 is a flowchart showing an example of a support information output process performed by the information processing device.

FIG. 9 is a flowchart showing an example of a future status information output process performed by the information processing device.

FIG. 10 is a flowchart showing a variation of the usage information update process performed by the information processing device.

FIG. 11 is a diagram showing an example of a display screen based on support information displayed on the notification device.

FIG. 12 is another example of a display screen based on support information displayed on the notification device.

FIG. 13 is a diagram showing an example of a display screen based on future status information displayed on the notification device.

FIG. 14 is another example of a display screen based on future status information displayed on the notification device.

FIG. 15 is a conceptual diagram of a computer system in the above embodiment.

FIG. 16 is a block diagram of the computer system.

FIG. 17 is yet another example of a display screen based on support information displayed on the notification device.

### DESCRIPTION OF EMBODIMENTS

Hereinafter, embodiments of the information processing device and the restaurant system using it will be described with reference to the drawings. Note that components having the same reference numerals in the embodiments perform similar operations and may not be explained again.

The terms used below are generally defined as follows. However, the meanings of these terms should not always be interpreted as shown here, and if they are specifically explained later, such explanations should also be taken into account for interpretation.

An "identifier" for a certain item is a character, symbol, or the like that uniquely indicates the item. The identifier may be an ID, for example, and as long as it can identify the corresponding item, its type does not matter. In other words, the identifier may be the name of the item itself or a code combination uniquely corresponding to it.

The term "acquire" may include acquiring information entered by a user and also include acquiring information stored in another device. Acquiring information stored in another device may involve acquisition via an API or scraping contents of document files provided by other devices (including web pages). It may also include acquisition of information from image files by performing optical character recognition (OCR), thereby obtaining information in a different format based on the original data.

Additionally, the acquisition of information may utilize machine learning methods. For example, a learner (learning information) that inputs specific input data and outputs the desired output data may be constructed using machine learning techniques. A model may be created by providing two or more input-output pairs to a learning module. This model may be stored in a storage unit and used as a classifier. The machine learning methods may include deep learning, random forest, SVM, etc., and the frameworks used may include fastText, tinySVM, random forest, TensorFlow, or various existing libraries. Acquiring information using such learners may be referred to as acquisition through machine learning.

Note that learners are not limited to those obtained through machine learning. For example, a learner may be a table indicating the correspondence between input vectors and output information. In such cases, the output information corresponding to the feature vector derived from the input information may be acquired from the table. Alternatively, a feature vector may be generated by using two or more input vectors and parameters for weighting each input vector. The final output information may be acquired using the corresponding output information and parameters of the used vectors. Such acquisition may be referred to as acquisition using correspondence. Furthermore, a learner may also be a function representing a relationship between input vectors and information used to generate output information. In this case, output information may be obtained by deriving corresponding information using the function. This may be referred to as acquisition using a function.

The term "output" of information includes displaying on a display, projection using a projector, printing with a printer, audio output, transmission to an external device, storage in a recording medium, and delivering processing results to other devices or programs. For example, it includes displaying information on a web page, sending by email, or outputting print data.

"Receiving" of information includes accepting inputs from input devices such as a keyboard, mouse, or touch panel, receiving data transmitted over wired or wireless communication from other devices, and reading data from recording media such as optical disks, magnetic disks, or semiconductor memory.

The term "update" of information stored in the information processing device includes modifying stored data, adding new data, or deleting part or all of the stored data.

### (Embodiment)

An overview of the present embodiment is as follows. The information processing device according to the present embodiment obtains and outputs prediction information including a prediction result of the user's next consumption behavior based on usage information related to the use of a restaurant store by the user. The usage information may include past usage information related to consumption behavior in previous visits, and may include information related to consumption behavior during the current dining opportunity of a visiting user. The usage information may also be next usage information related to a planned future visit input by the user who plans to use the store. Below, the configuration of such an information processing device and a restaurant system using the device will be described.

First, an example of a store where the restaurant system using the information processing device is applied will be described.

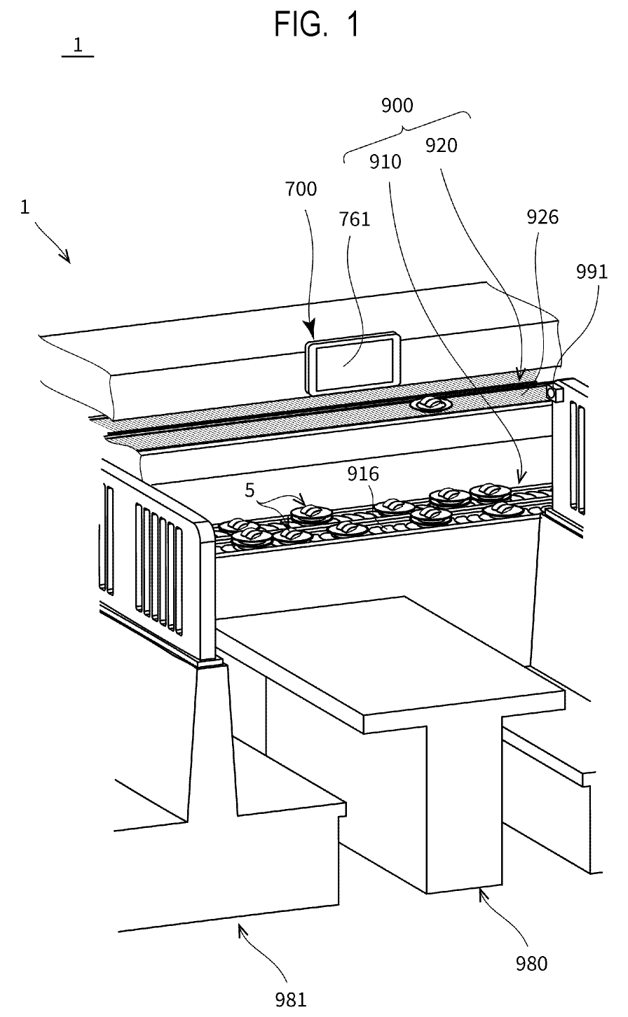

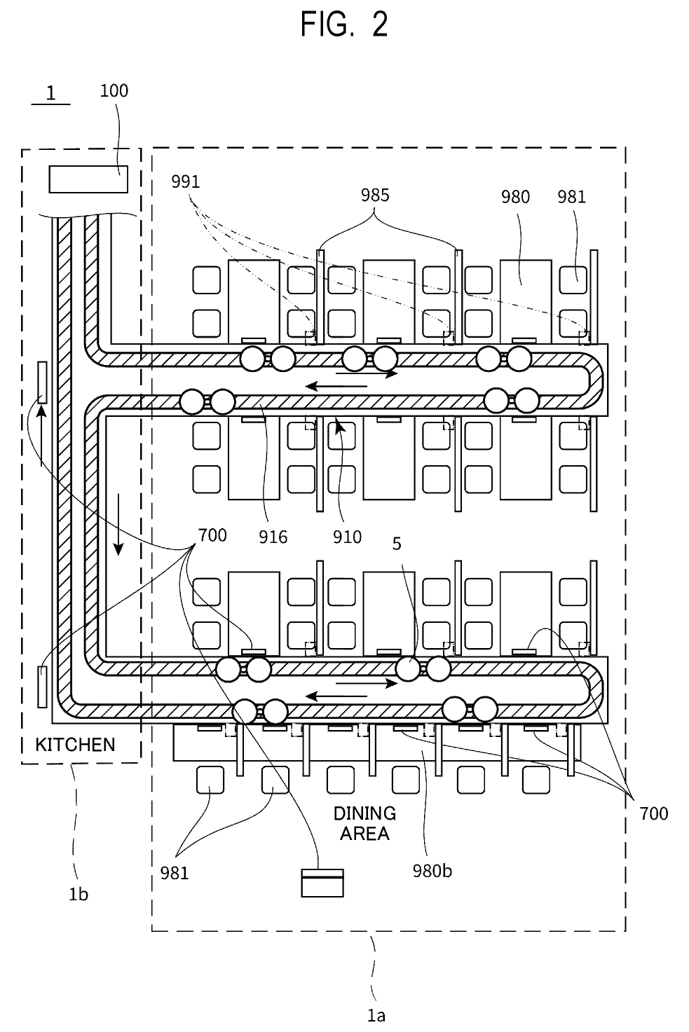

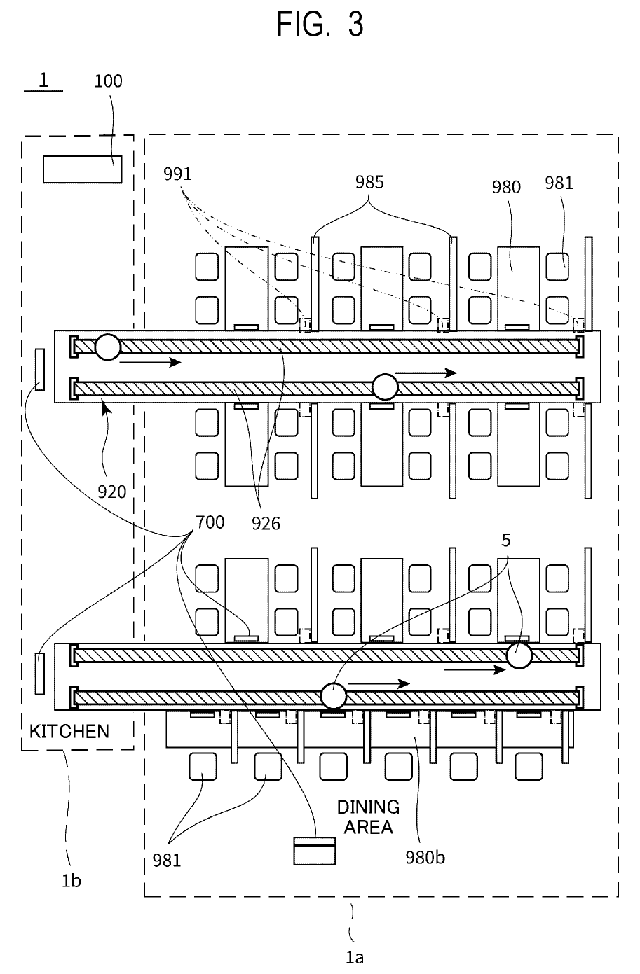

FIG. 1 is a diagram explaining an example of a conveyance device 900 and other elements used in a store where the restaurant system 1 according to the present embodiment is applied. FIG. 2 is a plan view showing an overview of the restaurant system 1. FIG. 3 is another plan view showing an overview of the restaurant system 1.

The restaurant system 1 according to the present embodiment is used, for example, in a restaurant or similar type of store. FIG. 1 shows some examples of fixtures. FIGS. 2 and 3 show examples of a first conveyance device 910 and a second conveyance device 920 within the store, such as a restaurant. The restaurant may be, for example, a so-called conveyor belt sushi restaurant. However, the store where the restaurant system 1 is applied is not limited to this type of business or industry, and it may be another type of restaurant or even a non-restaurant store. The products provided to users may be charged or free of charge.

In this embodiment, the term "product" refers to, for example, food items such as sushi. These may include nigiri sushi, hand-rolled sushi, or other dishes. The term may also include drinks, sweets, packaged food items, or food in containers. In addition to food, products may include other valuable items.

In this embodiment, the restaurant system 1 allows users who are customers to place orders for products at each seat. In the restaurant system 1, the conveyance device 900 is configured to convey products to the user's seat.

Here, the term "seat" is a concept referring to a seat or table used by the user as the delivery destination of the product. One seat corresponds, for example, to a customer group of one or more users who purchase the product (the customer group may include one or more users, including a single user). For instance, if a customer group consisting of multiple users visits a restaurant and is guided to one table in the store, that table corresponds to a seat. Similarly, if a single user is guided to a counter seat, that counter seat is also considered a seat. The seat is not limited to an actual physical seat or table. The seat may also be a unit for billing and providing products to a group consisting of one or more users, whether physical or virtual. That is, the seat is a concept indicating the billing unit and the delivery destination of the product.

In this embodiment, the restaurant has two or more seat groups in the store, each composed of two or more seats. A seat group may be regarded as a section conveniently divided for the purpose of store operation. For each seat group, staff may be assigned for serving or cleaning duties, or it may be determined whether to operate the seat group depending on the number of users. Usually, each seat group includes two or more seats that are physically located close to each other, but this is not limited. Seats within the same group may be located far apart in the store.

The restaurant system 1 includes a conveyance device 900, an information processing device 100, and a notification device (a display device) 700. In this embodiment, the conveyance device 900 includes two types: a first conveyance device 910 and a second conveyance device 920, but this is not a limitation.

The store where the restaurant system 1 is applied includes, for example, a dining area 1a where users eat and a kitchen 1b where products are prepared. In the dining area 1a, tables 980 and seats 981 are provided for users to dine. A counter table 980b, where users can eat in a row, may also be used as the table 980.

The notification device 700 is, for example, a reception terminal corresponding to each seat. One notification device 700 may be shared among two or more seats. Alternatively, two or more notification devices 700 may be assigned to one seat. The notification device 700 may be placed in the kitchen 1b and used by staff. In this case, the notification device functioning to notify staff is referred to as a staff notification device. The notification device 700 may also be placed in the passage of the dining area 1a and be used by users away from their seats (e.g., before being seated or after finishing a meal).

The notification function of the notification device 700 is typically realized by a processor and memory. That is, its functions are usually implemented by software (computer program code) stored in a recording medium such as ROM. However, some or all of the functions may be realized by a hardware circuit (dedicated circuit).

In this embodiment, a customer group can use a notification device 700 installed corresponding to their seat, which includes a display screen such as a touch panel (notification display unit 761), to place product orders.

In the drawings, a tablet-type information terminal device is shown as the notification device 700; however, a mobile information terminal device or a personal computer (PC) may also be used as the notification device 700.

In the restaurant system 1, users seated at corresponding seats can place orders for product 5 using an electronic menu displayed on the notification device 700. Known configurations may be used for accepting such orders. For example, the information processing device 100 may accept orders from each seat based on the user’s operations on the notification device 700 corresponding to each seat, and transmit the order details to a terminal provided in the kitchen 1b (not shown), thereby enabling the provision of product 5 according to the order.

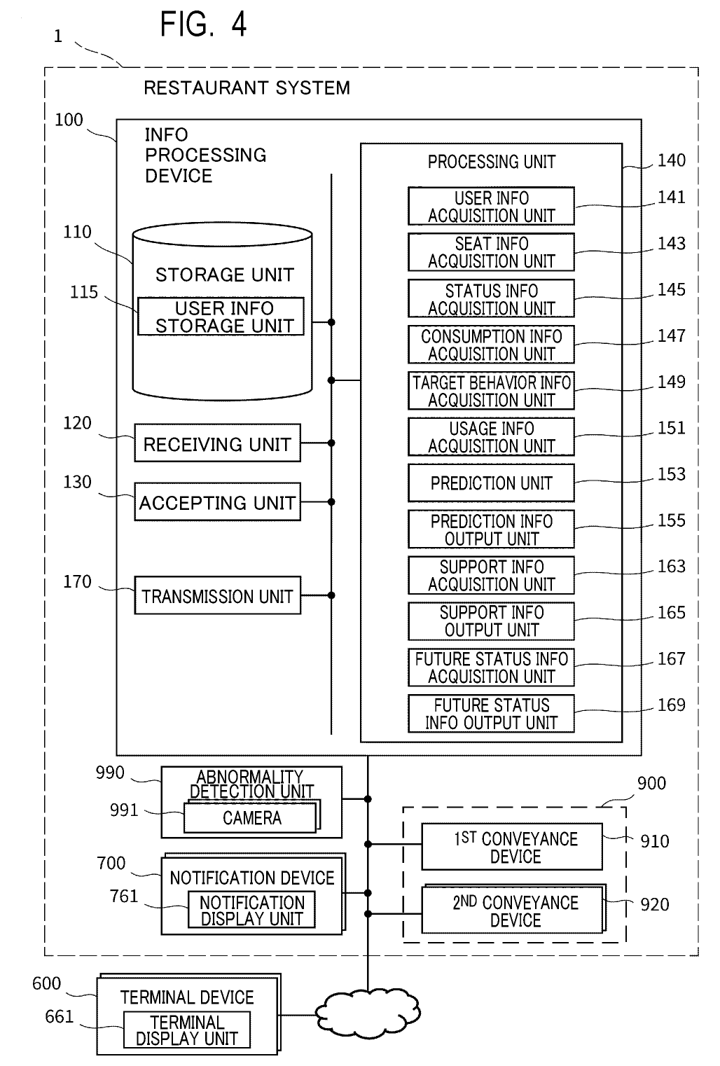

In this embodiment, the restaurant system 1 may also be used in combination with a terminal device 600 (see FIG. 4) that can communicate with the information processing device 100 via a network. The terminal device 600 may be considered part of the restaurant system 1 or not. The terminal device 600 is used, for example, by users. That is, the restaurant system 1 may be configured such that a user who is a customer of a restaurant or the like can use the system via a terminal device 600. In this case, the customer group may place orders using one or more terminal devices 600 that they own. A system configuration similar to that described in Patent Document 2 may be adopted in this case.

For example, a mobile information terminal device such as a so-called smartphone may be used as the terminal device 600. The terminal device 600 includes a terminal display unit 661 (as shown in FIG. 4), which is a screen such as a touch panel. Tablet-type information terminal devices or laptop computers (personal computers: PCs) may also be used as terminal device 600.

Note that the terminal device 600 may also be used by staffs such as hall staff. That is, the restaurant system 1 may be configured so that staffs can use it via the terminal device 600. For example, the staff may send information such as order details from each seat to the information processing device 100 using the terminal device 600, thereby enabling order reception.

In this embodiment, the notification device 700 is configured to receive information output (transmitted) from the information processing device 100 and to display the information on the notification display unit 761 based on the received information. When a terminal device 600 is used, it may similarly display information on the terminal display unit 661 based on the information received from the information processing device 100.

In the restaurant system 1, devices that can communicate with each other may communicate via a network such as a local area network or the internet, but this is not a limitation. There is no restriction on the number of each device included in the restaurant system 1, and other devices may also be included.

The conveyance device 900 is used to convey products to each seat. Hereinafter, the first conveyance device 910 and the second conveyance device 920 will be described respectively. Note that only the first conveyance device 910 or only the second conveyance device 920 may be used as the conveyance device 900. In addition, a conveyance device of a configuration different from the first conveyance device 910 and the second conveyance device 920 may be used together with the first conveyance device 910 or the second conveyance device 920 as the conveyance device 900. Furthermore, a conveyance device having a configuration different from the first conveyance device 910 and the second conveyance device 920 may be used alone as the conveyance device 900. For example, a traveling device that autonomously travels within the store 1a to serve products to each seat may be used as the conveyance device 900.

As shown in FIG. 2, a first conveyance device 910 includes a conveyance path 916 on which a plate carrying a product such as sushi is placed. The conveyance path 916 is laid out in the store interior 1a so that plates are conveyed in the vicinity of each table 980. The conveyance path 916 is configured, for example, using a crescent chain with a flat upper surface, but is not limited thereto. The conveyance path 916 conveys plates in a predetermined conveyance direction and circulates through the tables 980 in the store interior 1a and the kitchen 1b. Note that in FIG. 2, the second conveyance device 920 is omitted from the illustration.

A second conveyance device 920 is provided above the first conveyance device 910. Note that the vertical position of the second conveyance device 920 relative to the first conveyance device 910 is not limited to this configuration.

As shown in FIG. 3, the second conveyance device 920 includes a conveyance path 926 disposed above the conveyance path 916. A plate carrying a product 5 can be placed on the conveyance path 926. The conveyance path 926 is laid out in the store interior 1a so that plates are conveyed in the vicinity of each table 980. The conveyance path 926 is configured, for example, using a belt on which plates or the like can be placed, but may also be configured to move plate-holding platforms in the conveyance direction.

The conveyance path 926 is capable of conveying plates in a predetermined conveyance direction (indicated by an arrow in FIG. 2), thereby delivering products 5 to each table 980 in the store interior 1a. The conveyance path 926 is arranged in a top view so as to pass between seats arranged on opposite sides thereof, but this is not a limitation. Multiple conveyance paths 926 are provided in the store interior 1a. One end of each conveyance path 926 is located in the kitchen 1b.

The second conveyance device 920 is driven by a conveyance control unit that controls the operation of the second conveyance device 920. The conveyance control unit is, for example, a control circuit capable of controlling the driving of a motor (not shown) that drives the conveyance path 926. The conveyance path 926 is driven by the conveyance control unit so that plates carrying products 5 such as sushi are conveyed from the kitchen 1b to the store interior 1a.

In the present embodiment, the provision of products 5 or the like by the second conveyance device 920 can be carried out by specifying a destination seat. That is, the second conveyance device 920 is configured to be capable of conveying the product 5 or the like to a specified delivery destination. The delivery destination may be specified, for example, based on an instruction from a worker in the kitchen 1b or the like, or may be specified based on information output from the information processing device 100. The second conveyance device 920 conveys the product 5 from the upstream side toward the delivery destination, and stops the conveyance when the product 5 reaches the delivery destination. As a result, the user can reach out from the seat corresponding to the delivery destination and receive the product 5 stopped on the conveyance path 926.

In the present embodiment, the restaurant is capable of providing users with pre-made products (self-service products) prepared in advance for consumption, and order products provided in response to an order received from the user. The self-service products are provided by the first conveyance device 910. On the other hand, the order products are provided by the second conveyance device 920. In other words, in the present embodiment, the restaurant is a conveyor belt sushi restaurant that includes a first conveyance device 910 having a conveyance path 916 circulating within the store to provide self-service products, and a second conveyance device 920 different from the first conveyance device 910 and capable of conveying order products to specified delivery destinations. However, this configuration is not limiting, and the order products may also be provided by the first conveyance device 910.

The restaurant system 1 employs a detection device 991 used to detect specific target behaviors of the user (also referred to as record target behaviors) as described later. The restaurant system 1 includes an abnormality detection unit 990 that detects that an abnormality has occurred based on the detection result of the detection device 991. Here, the occurrence of an abnormality refers to, for example, the occurrence of a target behavior by the user, or a detection result indicating that such a behavior may have occurred. The abnormality detection unit 990 is configured to be capable of detecting an abnormality that occurred for each seat used by the user, although this is not limiting.

In the present embodiment, the detection device 991 is, for example, a camera (hereinafter sometimes referred to as camera 991). The camera 991 is configured, for example, to be installed one per seat and capable of capturing images (either still images or moving images) covering a predetermined detection area at each seat. The abnormality detection unit 990 can be said to detect the occurrence of an abnormality based on images captured by the camera 991.

Specifically, the target behavior refers, for example, to acts that may damage or devalue products or utensils corresponding to the seat, or to prescribed nuisance behaviors, but is not limited thereto. The target behavior may also be defined as actions differing from those normally performed during dining by users.

The abnormality detection unit 990 may be configured, for example, to detect the occurrence of an abnormality using learning information constructed based on input information including images capturing individuals performing actions considered as target behaviors or results of such actions, and images not including such individuals or results of such actions, along with output information indicating whether each image corresponds to a target behavior (or an abnormality).

As shown in FIG. 1, in the present embodiment, partitions 985 of a certain height are installed between seats, and each camera 991 is positioned to capture a space used by a single seat enclosed by the partitions 985. However, the position of the camera 991 is not limited to this configuration. Furthermore, a single camera 991 may be configured to capture images including multiple seats.

The detection device 991 may include a device other than a camera, such as a photoelectric sensor. A microphone or other device for detecting sound may also be used as the detection device 991. In this case, for example, actions that produce sounds exceeding a certain threshold may be treated as target behaviors.

FIG. 4 is a diagram illustrating a block configuration of the restaurant system 1.

As shown in the figure, the information processing device 100 includes a storage unit 110, a receiving unit 120, an accepting unit 130, a processing unit 140, and a transmitting unit 170.

The storage unit 110 includes a user information storage unit 115.

The storage unit 110 is preferably a non-volatile recording medium, but it may also be realized using a volatile recording medium. Various information acquired by each device is stored in the respective media, but the process of storing such information is not limited to this configuration. For example, the information may be stored via a recording medium, via information transmitted over a communication line, or via data input through an input device.

User information regarding users who utilize the store is stored in the user information storage unit 115. In the present embodiment, user information refers to information in which a user identifier, which identifies the user, is associated with information concerning that user. Various types of information may be included in the user information. User information may be accumulated in the user information storage unit 115 after being received by the receiving unit 120, accepted by the accepting unit 130, or obtained as a result of processing by the processing unit 140.

In the present embodiment, information related to individual users may be stored as user information. User information may include certain attribute values concerning the state of a user visiting a restaurant. Such attribute values may include, for example, the number of people in the group to which the user belongs, the time of visit (or the elapsed time since the visit), the duration of stay in the store, and the time the dining session ends (or the time of departure), among others. The user information may also include information such as the number of adults and the number of children included in the customer group. Further, the user information may also include an identifier for a worker responsible for various services for the seat used by the user. Furthermore, if another user who visits the store together with the user (a "companion user") can be identified, the user identifier of that companion user may also be included in the user information.

In the present embodiment, a portion of the user information used may be as follows.

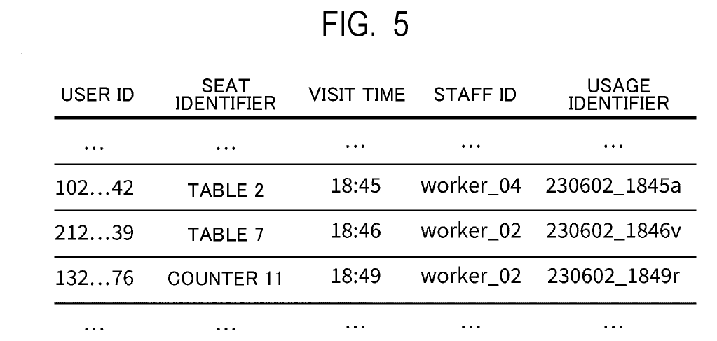

FIG. 5 is a diagram showing an example of the user information used by the information processing device100.

In the example shown in the figure, user information such as seat identification information, visit time, an identifier (staff ID) of the staff member responsible for service operations at the seat used by the user, and a usage identifier for identifying other information recorded per usage occasion are recorded in association with a user identifier (user ID) that identifies the user.

The seat identification information may include, for example, a table number that identifies the table 980 used by the user, or a seat number that identifies the seat 981 at a counter table 980b used by the user.

Thus, when an identifier related to the staff member responsible for a seat is included in the user information, the staff member corresponding to the user or seat can be identified based on the user information. The user information may also include information other than the above. For example, as described later, information concerning past visits may be included. Additionally, certain information (e.g., staff identifiers) may be stored separately from the user information. That is, information stored in the storage unit 110, etc., in a manner that allows association with a user identifier or seat identifier, or information obtainable in association with a user identifier or seat identifier, can be considered user information.

Furthermore, as an attribute value in the user information, a usage identifier related to usage information described later may also be included. The usage identifier can be used to identify the user's usage information that is separately recorded as user information. Note that the storage format for usage information is not limited to this example and can be set as appropriate.

The information that may be included in the user information can be described as follows. In the present embodiment, the user information storage unit 115 stores, as user information, usage information related to the use of a restaurant by a user, in association with a user identifier that identifies the user. The usage information may include, for example, the attribute values mentioned above concerning the state of the user during their visit to the restaurant, information about the products purchased at that time, and so on, but is not limited thereto. The usage information may be interpreted to include attribute information related to the user that was entered or obtained from the user, or such attribute information may be treated separately from the usage information. The attribute information may include, for example, the user's address, age, occupation, gender, preferences, and other information, but is not limited to these.

The usage information may include, for example, consumption information related to the user’s consumption behavior. The consumption behavior may include, for example, the purchase or consumption of the product 5, but is not limited to this. The consumption behavior may refer to actions such as ordering product 5 for purchase or staying in the store for the purpose of consuming the product 5. The consumption information may be, for example, information related to the purchase history of product 5. The purchase history-related information may include, for example, order information indicating the order status at each seat. The consumption information may be the consumption information for the seat corresponding to the user. If information related to the purchase history for each individual user in a customer group is available, consumption information for each user may be included in that user’s user information. Specifically, the consumption information may include, for example, the quantity of product 5 consumed, preference-indicating information such as the types or names of products 5 with relatively high consumption, the ordering method used, and the length of stay at the store, but is not limited to these.

The consumption information may be information related to ordering of products and is associated with a seat or a user. The consumption information may include, for example, a product identifier and the quantity ordered. The consumption information may be based on information sent from a terminal operable by the user, such as the notification device 700, during the user's dining occasion. The consumption information may be associated with seat identification information such as a seat identifier identifying the seat or a terminal identifier identifying the terminal device 600. Therefore, the consumption information can be said to be associated with the user.

The consumption information may include, for example, a product identifier and a price. The consumption information may also include information indicating that a plate carrying product 5 was served to the customer group. In other words, the consumption information may be post-order information. The consumption information may include, for example, the amount or quantity of product 5 consumed by the user. In the present embodiment, product 5 is provided to the user in units placed on plates. In this case, the number of plates of product 5 consumed by the user may be used as the consumption information.

The usage information may include information related to the operation of the second conveyance device 920 corresponding to the user. If the second conveyance device 920 is used exclusively for delivering ordered products, such information can be treated as data on the number, timing, or frequency of ordered products consumed, or the frequency of consumption. By using such information together with other consumption information, it is also possible to treat as usage information the absolute quantity of ordered products consumed, the ratio of ordered product consumption to self-service product consumption, the percentage of ordered products relative to total consumption, or the frequency at which ordered products are delivered.

In the present embodiment, the usage information may include past usage information regarding the user's consumption behavior during previous visits to restaurants. The term “restaurant” may refer to a specific single store or to multiple stores having a certain relationship (e.g., stores belonging to the same restaurant group). The past usage information may be consumption information from previous usage occasions, but is not limited thereto. The past usage information may also include time-related information such as the visit time, the duration of stay, and the departure time during previous visits. Furthermore, the past usage information may include group information concerning the group including the user during a previous visit, and consumption behavior information such as consumption information of the group. The group information may include, for example, the number of people in the customer group, but is not limited to this.

Note that the usage information may include usage information concerning the user’s current purchase history during the present dining occasion.

The usage information may also include next usage information relating to the user’s next planned visit, which was input by the user who is planning to use the restaurant. The next planned usage may refer to, for example, a scheduled visit to the restaurant in the future or the usage style intended by a user who has already visited the restaurant and is about to dine. That is, the next usage information may include, for example, reservation information for store usage provided in advance by the user, or information concerning the intended usage style of a user about to dine. The reservation information may include, for example, planned visit time (such as the scheduled arrival time or planned duration), the number of people in the customer group, the preferred type of seat (e.g., counter seat or table seat), or consumption information in the case where products 5 were pre-ordered, but is not limited to these. The intended usage style may include, for example, information such as the number of people in the customer group, the preferred type of seat, or consumption information in the case where products 5 were pre-ordered, but is not limited to these. The next usage information may be information that was input in advance by the user using the user’s terminal device 600 or the like, or information input by the user using the notification device 700 or the like after arriving at the restaurant.

The receiving unit 120 receives information transmitted from other devices. The receiving unit 120 is typically realized using a wireless or wired communication means but may also be realized using a means for receiving broadcasts.

The receiving unit 120 stores the received information, for example, in the storage unit 110. In the present embodiment, the user can input information or the like using the notification device 700 or the terminal device 600 and transmit it to the information processing device100. The receiving unit 120 can store the transmitted information in association with a terminal identifier or a seat identifier in the storage unit 110. That is, the receiving unit 120 can associate the received information with a user identifier. In the present embodiment, the receiving unit 120 receives consumption information transmitted from each terminal device 600 or notification device 700 and stores it in the storage unit 110 in association with a terminal identifier or a seat identifier. The receiving unit 120 may identify the seat identifier corresponding to the notification device 700 based on the transmitted information when receiving information from the notification device 700. Similarly, the receiving unit 120 may identify the terminal identifier based on the transmitted information when receiving information from the terminal device 600.

The accepting unit 130 accepts information input using an input means (not shown) connected to the information processing device 100. The accepting unit 130 stores the accepted information, for example, in the storage unit 110. The input means may be any device such as a numeric keypad, keyboard, mouse, or menu screen. The accepting unit 130 may be implemented as a device driver for input devices such as a numeric keypad or keyboard, or as control software for menu screens. The accepting unit 130 may also accept information input via a reading device (e.g., a code reader) connected to the information processing device 100 through an input operation (including information read by the device).

The accepting unit 130 may also be regarded as accepting, as input to the information processing device 100, the information received by the receiving unit 120. That is, the input of information into the information processing device 100 may be interpreted as including indirect input by the user through devices such as the notification device 700 or the terminal device 600.

The receiving unit 120 and the accepting unit 130 can also receive or accept information transmitted or input by staffs at the store.

The processing unit 140 performs various types of processing. The various types of processing refer to processing performed by each component of the processing unit 140, for example, as described below. The processing unit 140 is typically implemented using a processor and memory. The processing procedures of the processing unit 140 are typically implemented in software (computer program code), and such software is recorded on a recording medium such as ROM. However, part or all of the processing may alternatively be implemented by hardware (dedicated circuits).

Here, in the present disclosure, the term "processor" refers to a single or multiple hardware processors configured to execute program code included in a program (that is, one or more instructions constituting the program). In other words, "processor" is a hardware device capable of executing one or more programmed processes. For example, a processor may be a general-purpose or application-specific processor, such as a CPU, microprocessor, GPU, or DFP (data flow processor), but is not limited thereto.

In the present disclosure, the term "memory" refers to one or more hardware memories that are non-transitory tangible recording media, configured to record computer program code and/or data so that they are accessible by the processor. The memory may be implemented using memory technologies such as SRAM, SDRAM, non-volatile/flash-type memory, or other types of memory. The computer program code constituting the program is recorded on the memory and executed by the processor to enable the processing unit 140 to realize various functions.

In this embodiment, the processing unit 140 is configured to control the operation of the second transport device 920. Based on the control by the processing unit 140, the driving of the transport path 926 of the second transport device 920 is controlled, allowing products 5 to be delivered to specific seats.

In this embodiment, the processing unit 140 is configured to perform prediction related to the user's use of the store, based on user information. Such a prediction function is implemented by the processing unit 140 comprising a user information acquisition unit 141, a seat information acquisition unit 143, a status information acquisition unit 145, a consumption information acquisition unit 147, a target behavior information acquisition unit 149, a usage information acquisition unit 151, a prediction unit 153, a prediction information output unit 155, a support information acquisition unit 163, a support information output unit 165, a future status information acquisition unit 167, and a future status information output unit 169. Each of these components of the processing unit 140 may perform the following processes.

The user information acquisition unit 141 acquires user information regarding a user who is the target of prediction. The user information acquisition unit 141, for example, acquires user information corresponding to the user identifier of the target user or a seat identifier that identifies a seat associated with the user, from the user information storage unit 115.

The seat information acquisition unit 143 acquires seat information that includes information identifying the seat used by a user who has visited the store. The seat information acquisition unit 143 stores the acquired seat information in the user information storage unit 115 in association with a user identifier that identifies the user. For example, the seat information acquisition unit 143 acquires a seat identifier identifying the seat used by the user as seat information. Then, the seat identifier is stored as user information, associated with the user identifier, as the seat used by the user on that usage occasion. This makes it possible to identify the seat used by a specific user on a particular occasion.

In this manner, by storing seat information as user information, it becomes possible to identify the user based on the seat information. In addition, it becomes possible to output prediction information regarding the user using each seat.

The status information acquisition unit 145 acquires status information concerning the status of a particular store. The status information may include information indicating the level of busyness of the store (for example, congestion level). The congestion level may be an index represented based on factors such as the number of users in the store, the number of orders received, the number of orders per unit time, and the time taken from ordering to delivery of the product 5, but is not limited thereto. For example, each of these elements such as the number of users and number of orders may be used as the congestion level. Also, status information may include seat usage rate, the number of users per unit time, the number of reservations, or values obtained using these factors.

The status information acquisition unit 145 may, for example, acquire status information based on the status of the store (such as the number of orders or users) stored in the storage unit 110. In this embodiment, status information may include other users' user information for users who have visited the store, such as prediction information or consumption information obtained for other users, but is not limited thereto. For example, the status information acquisition unit 145 may also be configured to acquire status information based on images obtained by photographing the inside of the store using a camera 991.

The consumption information acquisition unit 147 acquires consumption information related to a current consumption behavior of a user who has visited the store. The consumption information acquisition unit 147 accumulates the acquired consumption information in the user information storage unit 115 as past usage information, in association with a user identifier identifying the user. The consumption information acquisition unit 147 may be configured to sequentially acquire consumption information of a user who is currently performing a consumption behavior. In this case, for example, the consumption information acquisition unit 147 may be configured to acquire consumption information based on the order reception status or dish collection status for the user. The consumption information acquisition unit 147 may also be configured to acquire consumption behavior related to the most recent dining occasion of the user at a certain point in time. In this case, for example, the consumption information acquisition unit 147 may acquire consumption information based on information such as an order history of a product 5 stored in the storage unit 110, in association with the user identifier identifying the user.

The target behavior information acquisition unit 149 acquires target behavior information related to a current record target behavior of a user who has visited the store. The target behavior information acquisition unit 149 accumulates the acquired target behavior information in the user information storage unit 115 as usage information, in association with the user identifier identifying the user. The target behavior, as described above, may be a predetermined behavior different from consumption behavior.

In this embodiment, the target behavior information acquisition unit 149 is configured to acquire the target behavior information based on a detection result indicating that an abnormality has occurred for a seat used by a user. The detection is performed by the abnormality detection unit 990. Based on the detection result that indicates an abnormality has occurred for each seat, the target behavior information of the user using the relevant seat can be accumulated.

The target behavior information acquisition unit 149 may also be configured to acquire target behavior information based on information input by a staff or the like. For example, when a staff recognizes that a user has performed a target behavior, the staff member may input information using the notification device 700 or the terminal device 600, and in response, the target behavior information may be accumulated. In this case, for example, the staff may input a user identifier or a seat identifier by a predetermined method, enabling the accumulation of the target behavior information.

The usage information acquisition unit 151 acquires usage information of a user from the user information storage unit 115. The usage information acquisition unit 151 is configured, for example, to acquire the usage information of a user when prediction is performed for that user.

The prediction unit 153 acquires prediction information based on the usage information obtained by the usage information acquisition unit 151. The prediction unit 153 is configured to acquire prediction information based on the usage information for each user. The prediction information refers to information that includes a prediction result of the user’s next consumption behavior.

Here, the prediction result of consumption behavior may include, for example, a predicted consumption amount of product 5, a predicted preference such as the type, name, or menu name of product 5 that is highly likely to be consumed, a predicted order quantity by the user, or a predicted duration of stay at the store, among others. The order quantity of product 5 refers, for example, to the amount of product 5 ordered deliberately by a user even though the product 5 is otherwise available through the first conveyance device 910 in a store, and delivered using the second conveyance device 920, but is not limited thereto. The order quantity may also refer to the order frequency, i.e., the number of orders per unit time.

The "next consumption behavior" may refer to a consumption behavior when the user visits the store in the future. Alternatively, it may refer to the future consumption behavior during the current visit, that is, the future consumption behavior within the current visit opportunity.

The acquisition of the prediction information may be performed using pre-constructed learning information. For example, various methods such as machine learning-based acquisition, function-based acquisition, or correspondence-based acquisition, as described above, may be used. In this case, the learning information may be constructed using usage information of two or more users accumulated in the past.

In the processing unit 140, it is also possible to perform processing to construct the learning information using past usage information for each user or for groups of two or more users with common attribute values. The prediction unit 153 may then use the learning information corresponding to the user to be predicted in order to predict the next consumption behavior.

Here, the user may be a single individual or a customer group.

In this embodiment, prediction information including a prediction result of the next consumption behavior of a customer group including any one user whose usage information is stored as user information may be acquired based on the usage information of the user and the number of members in the customer group. In other words, the prediction unit 153 may acquire prediction information including the prediction result of the next consumption behavior of a customer group including two or more users, based on the usage information of one user and the number-of-persons information relating to the customer group. When multiple persons visit the store, prediction information can be obtained based on the number of visitors. For example, for each customer group, prediction information such as a predicted consumption quantity of the product 5 and a predicted duration of stay in the store can be obtained. More specifically, as one example, prediction results such as "20 plates" and "30 minutes" may be obtained for a user visiting the store as a group of two, and "35 plates" and "40 minutes" when visiting as a group of four.

In this case, the number-of-persons information of the customer group may be information indicating the number of people by predetermined attribute values of each person. For example, the number of adults and children in the customer group may be used as the number-of-persons information.

In the case where prediction information is obtained for a customer group including any one user whose usage information is stored as user information, the prediction unit 153 may obtain prediction information as follows. For example, the prediction unit 153 may use group information related to the group including the user during a past use, and past usage information related to the consumption behavior of the group, to acquire the prediction information. This allows for more accurate acquisition of prediction information when visiting with multiple persons. If a new user is included in the group, prediction information may be obtained using information about average consumption behavior of users.

The prediction unit 153 may also be configured to acquire prediction information including the prediction result of the next consumption behavior of a group based on the usage information of each user in a customer group that includes two or more users. That is, if the customer group includes two or more users whose usage information is stored as user information, the prediction unit 153 may acquire prediction information for the customer group based on the usage information of each user. In this case, for example, prediction information for the customer group may be acquired by aggregating the usage information obtained for each user. Alternatively, prediction information may be acquired by averaging the prediction information obtained for each user based on their usage information and the number-of-persons information.

While a user or customer group that is the prediction target is currently visiting and dining at the store, the prediction unit 153 may acquire prediction information including a prediction result of future consumption behavior during the current usage opportunity, based on usage information related to past consumption behavior of the user in both past and current usage opportunities. In other words, the prediction unit 153 may repeatedly acquire (i.e., update) the prediction information during the user's ongoing use of the store. This allows output of prediction information on future consumption behavior based on the current usage information.

The prediction unit 153 may acquire prediction information related to the consumption of ordered products as prediction information. The prediction information related to ordered products may include, for example, the absolute quantity (e.g., number of plates or amount), the ratio of ordered products to self-service products, the proportion of ordered products in the total consumption, or the frequency of ordered product delivery. Such prediction information can be acquired based on, for example, information relating to the operation of the second transport device 920 corresponding to the user, obtained by the usage information acquisition unit 151 from the user information storage unit 115. This type of prediction information can be used to understand the extent to which ordered products are required, and is considered useful information. Especially in this embodiment, accurate prediction information can be output based on the operation information of the second transport device 920.

The prediction information output unit 155 outputs the prediction information. In this embodiment, the prediction information output unit 155 may, for example, accumulate the prediction information in the storage unit 110 (as an example of output). This allows the prediction information to be used for acquiring support information as described later. The output of prediction information is not limited to this. For example, the prediction information may be transmitted to a notification device 700 used by a store staff so that the staff can recognize it.

In this embodiment, the information processing device 100 is configured to output support information usable for store operation or future status information about the inside of the store using the prediction information.

The support information acquisition unit 163 acquires support information usable for store operation based on the prediction information acquired by the prediction unit 153 for a user who visited the store. The support information output unit 165 outputs the support information. The output of support information allows for easier store operation.

The support information may be, for example, seat guidance information regarding the seat to guide a user who has visited the store. The seat guidance information may include, for example, information specifying the seat such as a seat identifier, or information specifying a seat group composed of two or more seats in the store. It is desirable that the seat group be composed of multiple seats that are relatively close in position. The support information is not limited to the seat guidance information. For example, it may be information that instructs changes in the number of staff serving users or preparing product 5 in the kitchen. Furthermore, in a store that provides services tailored to user preferences, support information may include the user's preference details and information about services to be provided. Also, if a user's order is predicted, the predicted order information may be obtained as support information. If the prediction information itself can be used directly as support information, the support information acquisition unit 163 may be configured to obtain the prediction information as the support information.

In this embodiment, the support information acquisition unit 163 is configured to acquire the support information based on status information and prediction information. For example, the support information may be acquired in such a way that the store can be operated efficiently depending on the store’s situation and the prediction information. When acquiring seat guidance information as support information, for example, the information may be obtained based on status information such as seat availability or the elapsed time since the start of use of each seat, and prediction results such as the predicted stay duration of the user, so as to satisfy a predetermined criterion.

The predetermined criterion may be defined from various perspectives. For example, in order to avoid the concentration of users in a certain seat group after a certain period of time, the seat guidance information may be acquired such that the customer group's locations are more dispersed. This helps users use the store comfortably and reduces the burden on the staff responsible for each seat group. Also, a criterion may be set to ensure that each seat in a specific seat group becomes vacant at a specific time in the future. For example, when operations are designed to stop the use of a particular seat group during a relatively quiet time in the future, appropriate timing can be determined for ceasing its use, or to ensure that a reserved seat becomes available at the right time.

Support information may also be acquired as follows. That is, the support information acquisition unit 163 may acquire load information regarding store operations based on the prediction information for the user who visited the store and the status information. Then, the support information acquisition unit 163 acquires the support information based on the acquired load information. This allows the store to be operated more efficiently. The load information may include, for example, per-seat-group information such as order volume of product 5, order frequency, future usage rates of each seat, the number and frequency of events requiring staff involvement, among others. Load information may also indicate the future transition of these elements. When such load information is obtained, the support information acquisition unit 163 may guide the user to the seat group with the lowest load. Also, when multiple options are available for guiding the user, the unit may acquire load information for each option and obtain the support information accordingly.

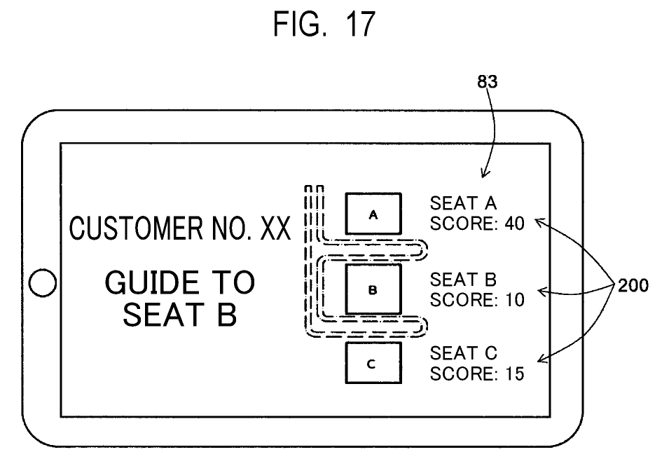

The support information acquisition unit 163 may also acquire scores 200 indicating the overall load on the store for each guidance option, and select the option with the least load as support information (see FIG. 17). This improves the store's operational efficiency.

In this embodiment, the support information output unit 165 may output user-related information as support information in a manner corresponding to the seat to which the user is guided. The manner may involve displaying the support information on the notification device 700 used at the seat or outputting the information in a way that staff responsible for the seat can confirm it. For example, the support information output unit 165 may output support information to the notification device 700 at the guided seat or to a terminal device 600 used by the staff responsible for the seat. This helps the guided user recognize the designated seat and the staff to identify the correct seat smoothly. It is possible to output information related to the user in a manner corresponding to the seat guided for the user who has visited the store, thereby enabling smooth store operation.

The support information may also include information such as the number of people in the customer group including the user. This allows staff corresponding to the guided seat to easily understand who will use the seat next, so that they can prepare or respond accordingly. Thus, the store can be operated smoothly. The support information may be output in forms other than just displaying the number of people on the notification device 700. For example, information based on prediction data may be sent to the staff's terminal or may be output as audio. Also, the support information may be broadcasted via the notification device 700.

The future status information acquisition unit 167 acquires future status information about the in-store situation based on the prediction information acquired for the current users of the store and for users who will visit in the future. The future status information output unit 169 outputs the acquired future status information so that store staff can confirm it. To make the information visible to the staff means to transmit the information to the notification device 700 or the terminal device 600 used by the staff. For example, if there is a notification device 700 that displays a seating chart, information indicating the status of seats in future may be shown on it as future seat status information. Alternatively, the information may be delivered via audio or other means.

The future status information may include, for example, the status of each seat or the vacancy rate several tens of minutes or hours later, but is not limited to these. It may also include sales data or the number of product 5 sold. The future status information acquisition unit 167 may use prediction information for each user currently using the store and for those who are scheduled to visit (e.g., reserved users) to acquire the future status information. If there are users waiting to be seated, prediction information about them may also be used to determine the future in-store status. This enables staff to perform their duties with a good understanding of future store conditions.

A transmission unit 170 transmits information to other devices via a network or the like. The transmission unit 170 may send information to the notification device 700 or the terminal device 600. In other words, the transmission unit 170 may output information to the notification device 700 or the terminal device 600.

The transmission unit 170 is typically implemented using a wireless or wired communication means but may alternatively be implemented using a broadcasting means.

In this embodiment, the information processing device 100 is configured to realize functions such as prediction by performing various operations as described below. These operations are executed as the processing unit 140 performs control operations using each of the components. Below, as a specific example of this embodiment, it is assumed that when a user visits the store and becomes ready to be guided to a seat, prediction information related to that user is acquired and seat guidance information is output as support information.

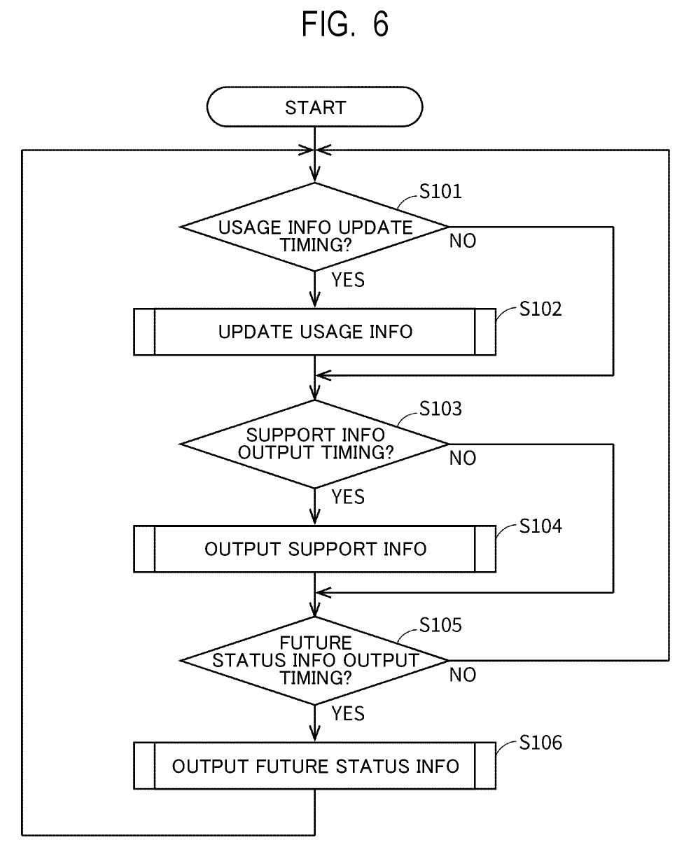

FIG. 6 is a flowchart showing an example of operations of the information processing device 100.

The processing shown in the figure is executed periodically, for example. However, this is not limiting, and it may also be triggered when certain predetermined execution conditions are satisfied (for example, arrival of a specified timing or detection of specified information).

(Step S101) The processing unit 140 determines whether the timing for updating the usage information has arrived. If the update timing is determined to have arrived, the process proceeds to Step S102; otherwise, it proceeds to Step S103. The update timing of the usage information may be periodic or triggered by the occurrence of a predetermined event. The predetermined event may be, for example, receipt of order information, provision of an ordered product, user entry or exit from the store, acceptance of a reservation, input of instructions by an employee, or detection of a target behavior, but is not limited thereto. It may also be triggered by the occurrence of a predetermined number of such events among two or more.

(Step S102) The processing unit 140 performs a usage information update process. Details of the usage information update process will be described later.

(Step S103) The processing unit 140 determines whether the timing for outputting the support information has arrived. If it is determined that the output timing has arrived, the process proceeds to Step S104; otherwise, it proceeds to Step S105. For example, when a new user is guided to a seat upon visiting the store, the processing unit 140 may determine that the timing for outputting the support information has arrived. The timing for outputting the support information may be periodic or triggered by a predetermined event, such as acceptance of a reservation or input of instructions by an employee, but is not limited thereto.

(Step S104) The processing unit 140 performs the support information output process. Details of the support information output process will be described later.

(Step S105) The processing unit 140 determines whether the timing for outputting the future status information has arrived. If it is determined that the output timing has arrived, the process proceeds to Step S106; otherwise, it returns to Step S101. For example, if an instruction by a staff is received via the notification device 700 or the like, the processing unit 140 may determine that the timing for outputting the future status information has arrived. The output timing for the future status information may also be periodic and is not limited to this.

(Step S106) The processing unit 140 performs the future status information output process. Details of the future status information output process will be described later. Thereafter, the process returns to Step S101.

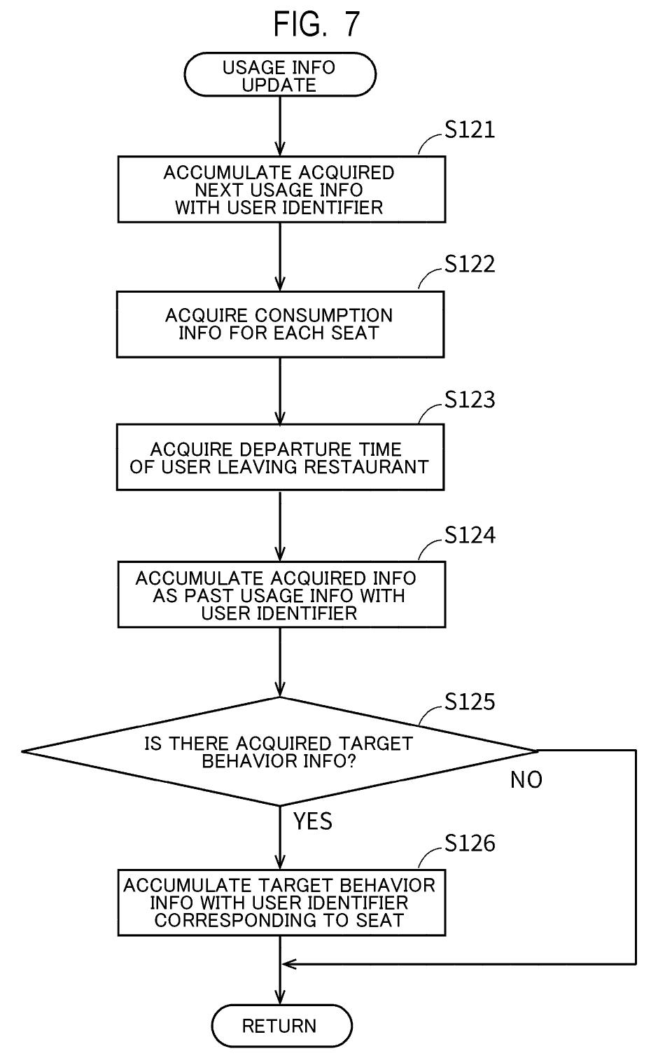

FIG. 7 is a flowchart illustrating an example of the usage information update process performed by the information processing device 100.

(Step S121) The processing unit 140 acquires the next usage information for one of the users and stores it in association with the user identifier. In other words, the next usage information for the user is updated. This process may be executed only when newly accepted next usage information, which has not yet been stored, is available.

(Step S122) The processing unit 140 acquires consumption information for each seat. This process may be executed only when newly obtainable consumption information, which has not yet been stored, is available. For example, consumption information obtained after the last usage information update process may be the target.

(Step S123) If there is a customer who has left the store, the processing unit 140 acquires the time of departure. For example, the departure time may be defined as the time when the checkout is completed, or the time when an instruction indicating the end of use is given, but it is not limited to these.

(Step S124) The processing unit 140 stores the information acquired in Step S122 and Step S123 as past usage information in association with the user identifier of the corresponding user. In other words, the past usage information for each user is updated.

(Step S125) The processing unit 140 determines whether target behavior information has been acquired. If it is determined that the target behavior information has been acquired, the process proceeds to Step S126; otherwise, the usage information update process ends.

(Step S126) The processing unit 140 stores the acquired target behavior information in association with the user identifier of the user determined to have performed the target behavior, as usage information. Thereafter, the usage information update process ends. The user determined to have performed the target behavior may be identified based on information specifying the seat for which an abnormality has been detected by the abnormality detection unit 990.

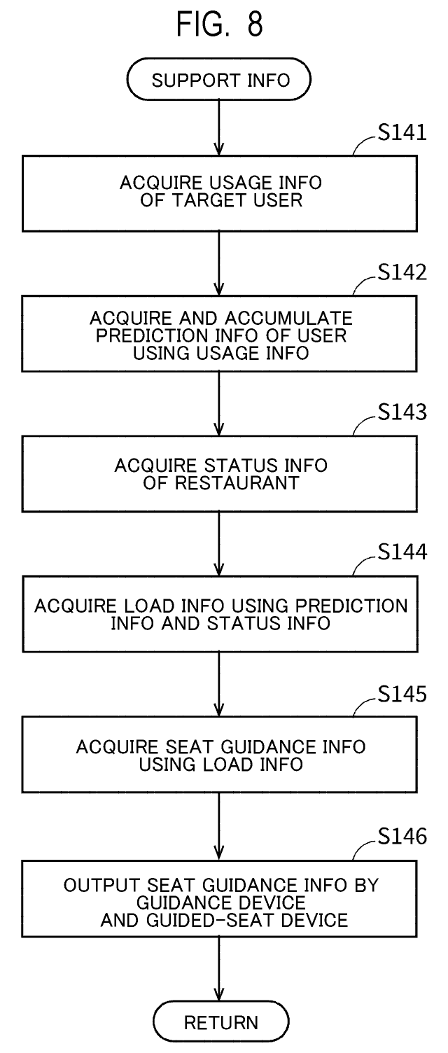

FIG. 8 is a flowchart illustrating an example of the support information output process performed by the information processing device 100.

The processing unit 140 first acquires prediction information for the target user, such as a user who has become ready to be guided to a seat.

(Step S141) That is, the processing unit 140 acquires the usage information of the target user from the user information storage unit 115.

(Step S142) The processing unit 140 uses the usage information to acquire and output the prediction information of the user. For example, the processing unit 140 may perform the output by storing the prediction information in the user information storage unit 115.

(Step S143) The processing unit 140 acquires the status information.

Next, the processing unit 140 acquires seat guidance information as support information using the prediction information and the status information.

(Step S144) That is, the processing unit 140 acquires load information using the prediction information and the status information of the user.

(Step S145) The processing unit 140 acquires seat guidance information using the load information.

(Step S146) The processing unit 140 outputs the acquired seat guidance information. For example, the seat guidance information is output so that it is displayed based on the seat guidance information on an in-store notification device 700 viewable by the user or the staff responsible for guidance, or a notification device 700 located at the guided seat. Thereafter, the support information output process ends.

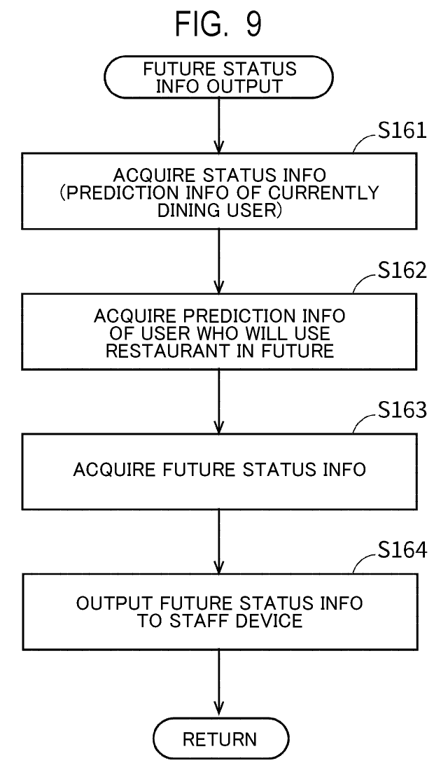

FIG. 9 is a flowchart illustrating an example of the future status information output process performed by the information processing device 100.

(Step S161) The processing unit 140 acquires prediction information regarding users currently using the store. In other words, the processing unit 140 acquires status information including prediction information for currently using users. The prediction information previously acquired and stored in the user information storage unit 115 during the support information output process or the like may be used. Alternatively, the prediction information for each user may be newly acquired based on their usage information.

(Step S162) The processing unit 140 acquires prediction information of users who will use the store in the future. For example, the processing unit 140 may acquire prediction information based on the next usage information and past usage information of the user.

(Step S163) The processing unit 140 acquires the future status information using the prediction information obtained in Step S161 and Step S162.

(Step S164) The processing unit 140 outputs the acquired future status information. For example, the future status information is output so that it is displayed on a notification device 700 or a terminal device 600 used by staffs, based on the future status information.

Note that in the above explanation, the usage information update process may be performed only for users who meet certain predetermined conditions. The predetermined condition may be, for example, that the user has completed a dining session (e.g., completed payment or left the store), but it is not limited thereto. In such a case, the usage information update process may be performed as follows.

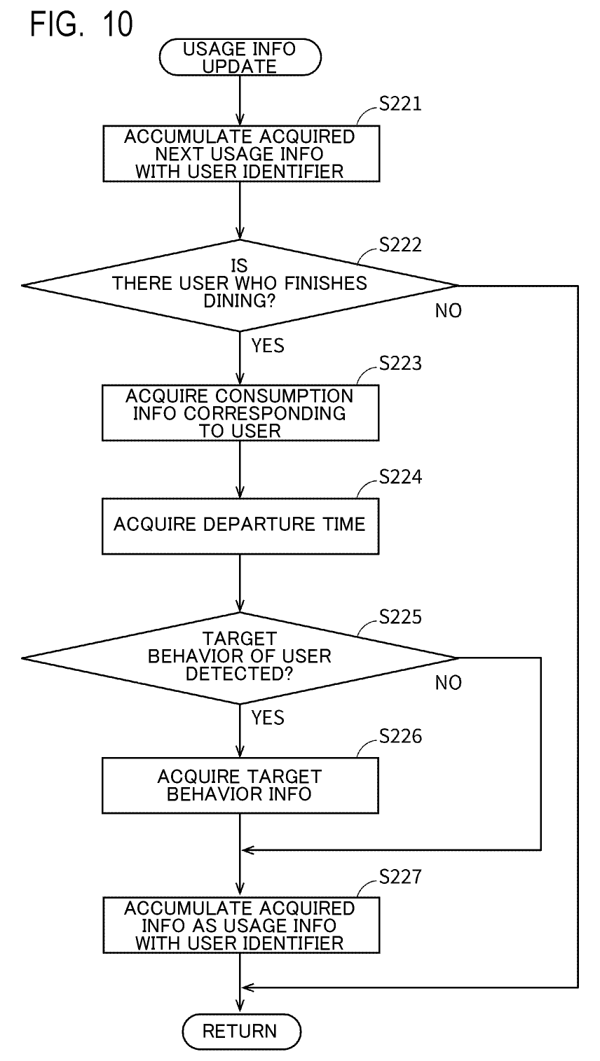

FIG. 10 is a flowchart illustrating a modified example of the usage information update process performed by the information processing device 100.

(Step S221) The processing unit 140 acquires the next usage information for one of the users, similarly to Step S121 described above, and stores it in association with the user identifier.

(Step S222) The processing unit 140 determines whether there is any user who has completed a dining session after the previous usage information update process. If there is a user who has completed the session, the process proceeds to Step S223 and beyond for that user as a target for update. Otherwise, the usage information update process ends.

(Step S223) The processing unit 140 acquires consumption information corresponding to the user targeted for update.

(Step S224) The processing unit 140 acquires the departure time of the user targeted for update.

(Step S225) The processing unit 140 determines whether target behavior information corresponding to the user targeted for update has been acquired. If it has been determined that such information has been acquired, the process proceeds to Step S226; otherwise, it proceeds to Step S227.

(Step S226) The processing unit 140 acquires the target behavior information corresponding to the user targeted for update.

(Step S227) The processing unit 140 stores the acquired information for the user targeted for update as past usage information, in association with the user identifier of the user. Thereafter, the usage information update process ends.

When the prediction function is used as described above, support information and future status information are output. In this embodiment, when such support information or future status information is output, the notification device 700 or the like that serves as an output destination device may display an output screen as shown below, allowing staff to confirm the information. This example assumes a case where information is output for displaying a screen for staff members to confirm the support or future status information.

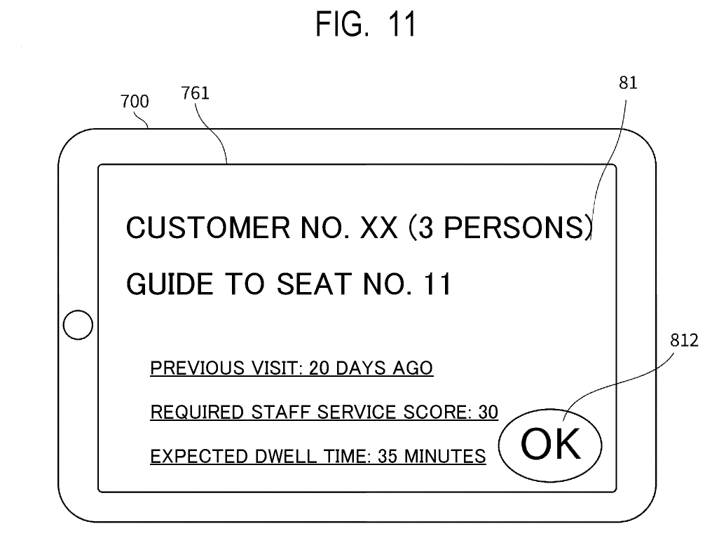

FIG. 11 is a diagram showing an example of a display screen 81 based on the support information displayed on the notification device 700.

As shown in the figure, in this embodiment, when support information is output by the notification device 700, the notification display unit 761 of the notification device 700 displays the screen 81 based on the support information. In the example shown in the figure, the display screen 81 is an example intended for staffs to view on a notification device 700 installed so that store staff can confirm it while attending to customers inside the store.

The display screen 81 shows, for example, information indicating the seat to which a specific user should be guided, such as “Please guide to Seat 11,” along with information indicating that the user should be guided to that seat. Additionally, in this embodiment, information indicating the number of customers is displayed to help the staff easily recognize the number of customers and distinguish the customer to be guided from others. The display screen 81 includes a confirmation button 812, which, when operated, transitions the screen to another one.

The display screen 81 may also display reference information based on usage information or prediction information for the user to be guided. Such reference information may include, for example, the timing of the user’s previous visit or the predicted stay duration. This allows staff members to understand how the user utilizes the store, whether the user is familiar with the store, and until when the user is expected to dine, so that appropriate customer service can be provided. Additionally, as reference information, data indicating the degree to which the staff member in charge of the seat will need to be involved with the user may be used. This data may be presented, for example, as a score indicating the level of involvement. By displaying prediction results and past records of such scores together, staffs can understand the likely degree of service required, such as delivering ordered products or providing other customer assistance, and prepare accordingly. This reference information can be considered a type of support information. Displaying such reference information enables staffs to perform their duties with that information in mind, allowing for more efficient and attentive service to the user.

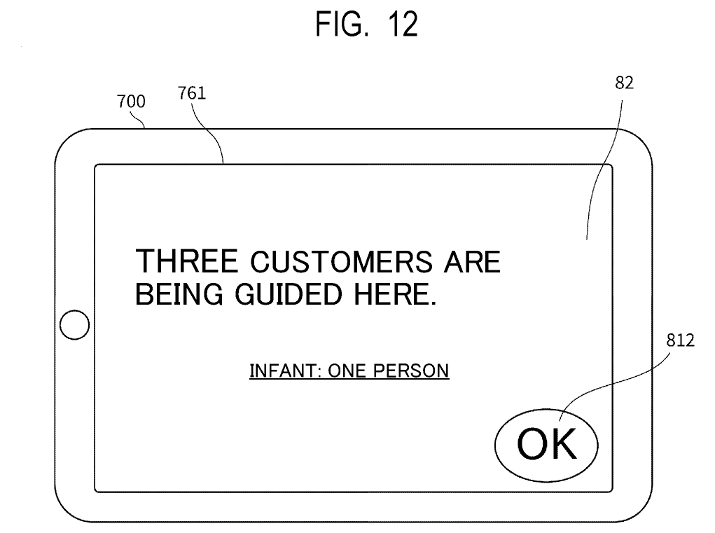

FIG. 12 is a diagram showing another example of a display screen 82 based on support information displayed on the notification device 700.

In the example shown in the figure, the display screen 82 is an example intended for staffs to view on a notification device 700 installed at the seat where a customer is to be guided.

The display screen 82 shows, for example, information indicating that a customer will be guided to the seat where the notification device 700 is installed. By displaying this information, staffs preparing the seat for the next customer can get ready appropriately. In this embodiment, information indicating the number of customers is also displayed to help the staff easily recognize the number of customers and distinguish the customer to be guided from others. This is especially useful when seat preparation must be adjusted based on the number of people. Additionally, the example shown in the figure displays information about users among the group who may require special preparations such as tableware, cutlery, or seat arrangements (e.g., infants). Thus, staff members who check the display screen 82 can make preparations for such users in advance, enabling smoother store operations.

FIG. 17 is a diagram showing another example of a display screen 83 displayed on the notification device 700.

In this example, display screen 83 shows, along with the information indicating the seat to which the user is to be guided, scores 200 indicating the operational load on the store assuming the customer is guided to each of the seat groups A to C. This scores 200 are obtained as load information by the processing unit 140. More specifically, the scores 200 are calculated based on at least one of the following for each seat group A to C: the quantity of product orders, order frequency, future usage rate of each seat, and the number of events requiring staff involvement.

On the display screen 83, the corresponding score 200 is displayed for each seat group A to C. The magnitude of the score 200 indicates the magnitude of the load, and in the example shown in the figure, it indicates that guiding the customer to seat group A is expected to result in the highest load. On the other hand, guiding the customer to seat group B is expected to result in the lowest load. Therefore, seat group B is displayed on the display screen 83 as the guidance destination. For seat group C, the score is 15, which is larger than that of seat group B but still sufficiently smaller than that of seat group A.

In this way, by displaying the scores 200 of each seat group A to C together on the display screen 83, staffs can grasp the load that will result from guiding a customer. Taking the score 200 into account, it is also possible for staff to guide a customer to a designated seat at their own discretion. For example, even though seat group B is displayed as the guidance destination on the display screen 83, the score 200 shows that guiding to seat group A would not significantly increase the load. Thus, depending on the situation in the store (for example, if the designated seat group B is dirty), the staff may decide to guide the customer to seat group A. This allows for flexible store operations and makes it possible to provide more attentive service to users.

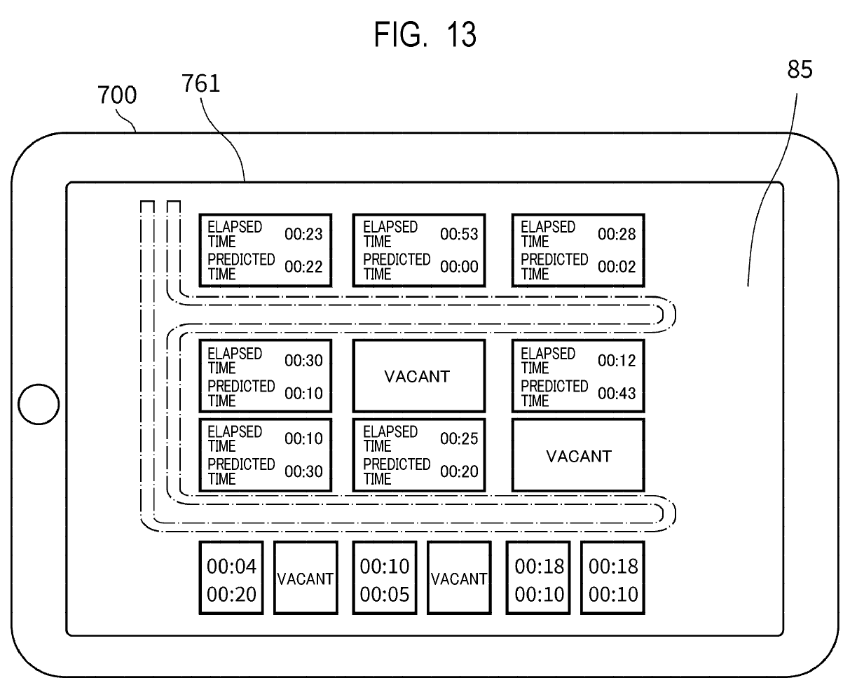

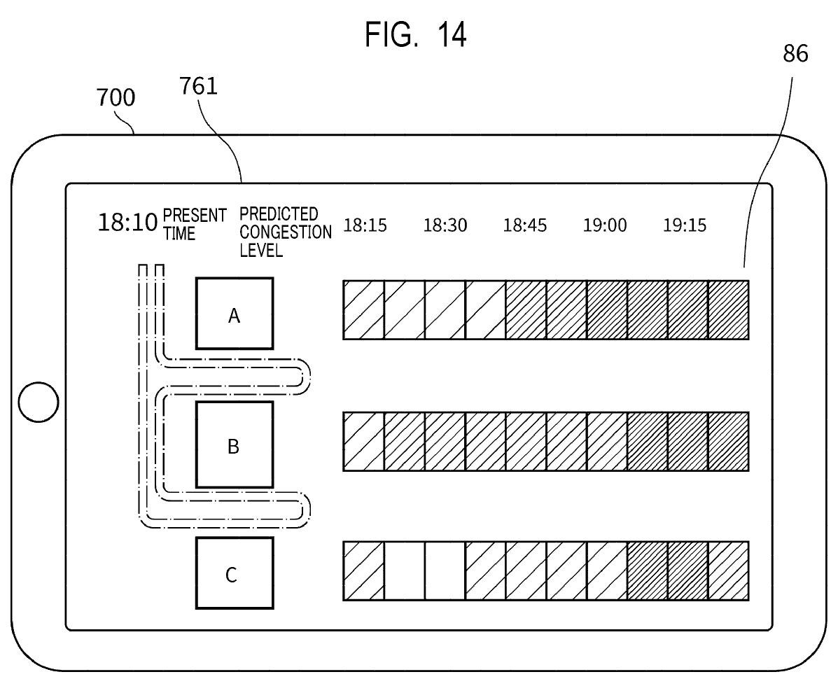

FIG. 13 is a diagram showing an example of a display screen 85 based on future status information displayed on the notification device 700. FIG. 14 is a diagram showing another example of a display screen 86 based on future status information displayed on the notification device 700.

As shown in the figures, in this embodiment, when future status information is output by the notification device 700, the notification display unit 761 of the notification device 700 displays the display screens 85 and 86 based on the future status information. In the examples shown in the figures, the display screens 85 and 86 are examples intended for staff to view on notification devices 700 installed for staffs to confirm while attending to customers inside the store.

In the examples described below, display screen 85 displays information about the usage status of each seat, including prediction results for future status (for example, predicted time until the end of use). Display screen 86 displays prediction results for the future status of each seat group, for example, visually showing predicted congestion levels for each seat group. In this embodiment, these displays are illustrated schematically in correspondence with the positional relationship of each seat or seat group in the store, making it easy for staff to grasp the displayed content.

On the display screen 85, the usage status of each seat is displayed as follows. For example, if a seat is not being used by a customer, it is displayed as vacant. If a seat is being used, the elapsed time since the start of use and the prediction result of the time until the end of use (predicted time) are displayed. This allows staff to easily confirm the elapsed time since the start of use for each seat. Additionally, by displaying the predicted time until the end of use, staff can easily recognize how soon each seat is likely to become vacant. Therefore, useful information is provided for staff to carry out their duties efficiently.

On the display screen 86, the future congestion levels of each seat group are displayed as follows. For example, for each future time period, the congestion level of each seat group is shown with shading. Congestion levels may vary depending on factors such as the frequency of orders and the number of users in each seat group, but are not limited thereto. In the display screen 86, for example, time periods expected to have higher congestion levels are shown with darker shading, enabling staff to easily grasp when and in which seat group congestion is likely to occur. For time periods or seat groups with higher congestion levels, countermeasures such as temporarily increasing the number of staff assigned can be taken. Thus, the store can be operated more efficiently, and appropriate service can be provided to customers. Note that the method of displaying congestion levels is merely an example, and the levels may also be shown as graphs of transitions or as scores.

As described above, in the information processing device 100, prediction information including prediction results of the next consumption behavior of users who use the store can be output based on usage information related to store usage. The usage information may include past usage information relating to consumption behavior in past usage sessions and next usage information relating to future planned usage. This makes it possible to predict the next consumption behavior of users who use the store with high accuracy. Furthermore, since support information and future status information can be output using the prediction information, the store can be operated more efficiently.

The processing in this embodiment may be realized by software. This software may be distributed via software downloads or the like. The software may also be recorded on a recording medium such as an optical disk and distributed. The software for realizing the information processing device 100 of this embodiment is a program as follows. That is, this program functions to make a computer, which can access a user information storage unit in which usage information related to the use of a restaurant store by a user is stored in association with a user identifier identifying the user, function as: a usage information acquisition unit that acquires usage information of the user from the user information storage unit; a prediction unit that acquires prediction information including a prediction result of the next consumption behavior of the user based on the usage information; and a prediction information output unit that outputs the prediction information.

### (Others)

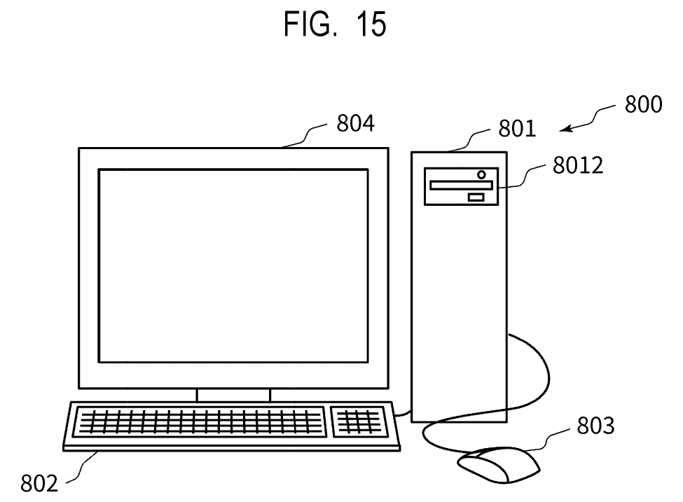

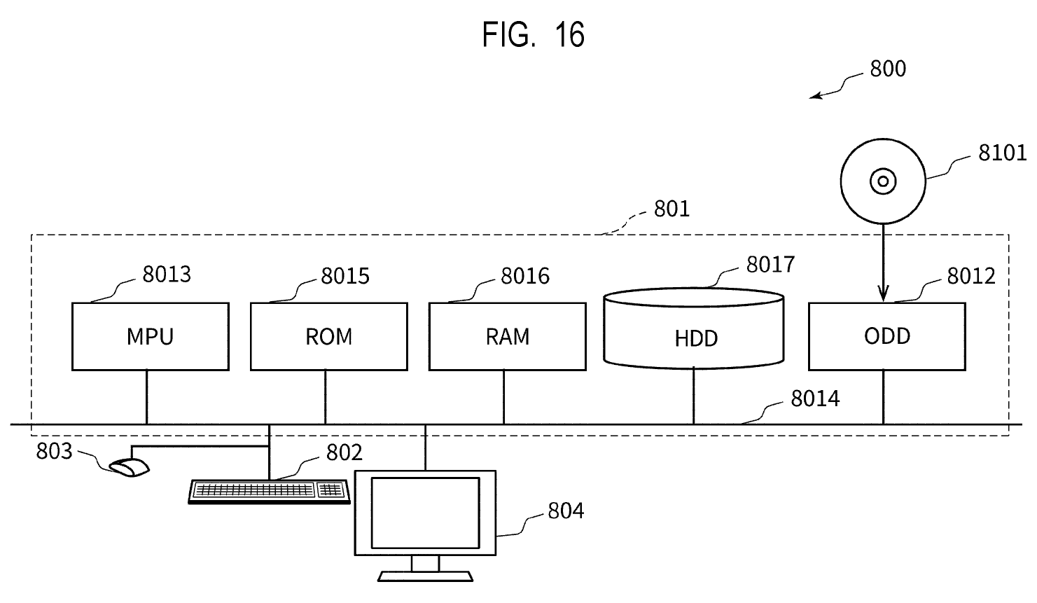

FIG. 15 is an overview diagram of the computer system 800 according to the embodiment described above. FIG. 16 is a block diagram of the computer system 800.

In these figures, an example configuration of a computer that executes the program described in this specification to realize the information processing device of the above embodiment is shown. The embodiment described above can be implemented by computer hardware and computer programs executed on the hardware.

The computer system 800 includes a computer 801 having an optical disk drive, a keyboard 802, a mouse 803, and a monitor 804.

The computer 801 includes, in addition to an optical disk drive (ODD) 8012, an MPU 8013, a bus 8014 connected to the optical disk drive 8012 and others, a ROM 8015 for storing programs such as a boot-up program, a RAM 8016 connected to the MPU 8013 for temporarily storing instructions of application programs and providing temporary storage space, and a hard disk (HDD) 8017 for storing application programs, system programs, and data. Although not shown, the computer 801 may further include a network card providing a connection to a LAN.

A program for executing functions such as the information processing device of the above embodiment in the computer system 800 may be stored on an optical disk 8101, inserted into the optical disk drive 8012, and transferred to the hard disk 8017. Alternatively, the program may be transmitted to the computer 801 via a network (not shown) and stored in the hard disk 8017. At the time of execution, the program is loaded into the RAM 8016. The program may also be loaded directly from the optical disk 8101 or the network.

The program does not necessarily include an operating system (OS) or third-party programs that cause the computer 801 to execute the functions of the information processing device of the above embodiment. The program only needs to include the portion of instructions that call appropriate functions (modules) in a controlled manner to obtain the desired result. The operation of the computer system 800 is well known, and detailed description is omitted.

In the above program, the transmission step for transmitting information and the reception step for receiving information do not include processes performed by hardware, such as processes executed by a modem or interface card in the transmission step (i.e., processes performed only by hardware).

The computer that executes the above program may be a single computer or multiple computers. In other words, centralized processing may be performed, or distributed processing may be performed.

In the embodiment described above, two or more components present in one apparatus may be physically implemented in one medium.

In the above embodiment, each component may be constituted by dedicated hardware, or, for components that can be realized by software, they may be realized by executing a program. For example, each component can be realized by having a program execution unit such as a CPU read and execute software programs recorded on a recording medium such as a hard disk or semiconductor memory. During execution, the program execution unit may access the memory or recording medium while executing the program. Furthermore, the program may be executed by being downloaded from a server, or executed by being read from a predetermined recording medium (for example, an optical disk, magnetic disk, or semiconductor memory). The program may also be used as a program constituting a program product. The computer that executes the program may be a single computer or multiple computers. In other words, centralized processing or distributed processing may be performed.

In the above embodiment, each process (each function) may be realized by centralized processing performed by a single apparatus (system), or by distributed processing performed by a plurality of apparatuses. In this case, the entire system composed of a plurality of apparatuses performing distributed processing can be regarded as one “apparatus.”

In the above embodiment, information transfer between components may be performed as follows. When the two components involved in the transfer of information are physically different, the transfer may be performed by outputting the information by one component and receiving it by the other component. When the two components are physically the same, the transfer may be performed by shifting from the processing phase corresponding to one component to the processing phase corresponding to the other component.

In the above embodiment, information related to the processing executed by each component, for example, information received, acquired, selected, generated, transmitted, or received by each component, or information such as thresholds, formulas, or addresses used in processing, may be temporarily or permanently stored in a recording medium not shown in the figures, even if not explicitly described. Such accumulation of information may be performed by each component or an unillustrated storage unit. Similarly, reading of information from the unillustrated recording medium may be performed by each component or an unillustrated reading unit.

In the above embodiment, information used by each component, for example, thresholds, addresses, or various setting values used in processing, may be changeable by the user, even if not explicitly described. In such cases, the user may be allowed to change the information as appropriate, or may not be allowed to do so. If changeable by the user, the change may be realized by an unillustrated reception unit that receives a change instruction from the user and an unillustrated modification unit that modifies the information in response to the instruction. The reception of the change instruction by the unillustrated reception unit may be performed via an input device, by receiving information transmitted over a communication line, or by receiving information read from a predetermined recording medium.

The present disclosure is not limited to the embodiments described above and various modifications are possible, which are also included within the scope of the disclosure.

Embodiments may be constituted by appropriately combining the embodiments and modifications described above. In addition, some components or functions of the embodiments or modifications may be omitted.

### (Configuration)

The configuration of the information processing device according to the embodiment described above can be expressed as follows.

That is, the information processing device includes: a user information storage unit that stores, in association with a user identifier identifying a user, usage information related to the use of a restaurant store by the user; a usage information acquisition unit that acquires usage information of the user from the user information storage unit; a prediction unit that acquires prediction information including a prediction result of the next consumption behavior of the user based on the usage information; and a prediction information output unit that outputs the prediction information. Here, the information processing device may further include a target behavior information acquisition unit that acquires target behavior information relating to a predetermined recordable behavior of the user who visited the store, the behavior being different from consumption behavior, and accumulates the acquired target behavior information in the user information storage unit as usage information in association with the user identifier.

In the above configuration, the target behavior information acquisition unit may be configured to acquire the target behavior information based on a detection result indicating that an abnormality has occurred for each seat used by the user, detected by an abnormality detection unit used in the store.

With such a configuration, it is possible to accumulate target behavior information about the user using a seat, based on the detection result that an abnormality has occurred for the seat.

In the above configuration, the restaurant may provide self-service products prepared in advance for consumption by the user, and ordered products provided to the user in response to orders received from the user. The prediction information may include information relating to the consumption of the ordered products.

With such a configuration, it is possible to output prediction information relating to the consumption of ordered products.

In the above configuration, the information relating to the consumption of ordered products may include the absolute number of consumption of ordered products, the ratio of consumption of ordered products to consumption of self-service products, the proportion of ordered product consumption in the total consumption, or the frequency of provision of ordered products.

With such a configuration, it is possible to output prediction information that enables the extent to which ordered products are required to be understood.

In the above configuration, the restaurant is a conveyor-belt sushi restaurant including a first conveyance device having a conveyance path that circulates within the store to provide self-service products, and a second conveyance device different from the first conveyance device, capable of conveying ordered products to specific destinations. The usage information acquisition unit may be configured to acquire, as usage information, information relating to the operation of the second conveyance device corresponding to the user.

With such a configuration, prediction information can be output more accurately based on the information relating to the operation of the second conveyance device.

As described above, the information processing device according to the present disclosure has the effect of being able to predict the next consumption behavior of a user who uses a restaurant store, based on usage information, and is useful as an information processing device and the like.

1. A display system for optimally guiding customers to seats in a restaurant, comprising:
an information processing device; and
a display device displaying an image to a staff of the restaurant, wherein
the information processing device is configured to:
store, in a user information storage unit in association with a user identifier identifying a user, usage information relating to use of the restaurant by the user, the usage information including past usage information relating to consumption behavior by the user in a past usage opportunity;
acquire, based on the usage information acquired from the user information storage unit, prediction information including a prediction result of the consumption behavior by the user who has visited the restaurant;
acquire, based at least on a number of users in the restaurant, status information indicating a busyness level of the restaurant;
acquire, as support information usable for operation of the restaurant, seat guidance information for guiding the user who has visited the restaurant to a seat in the restaurant based on the prediction information acquired for the user who has visited the restaurant and the status information of the restaurant; and
output the seat guidance information to the display device,
the display device is configured to, upon receiving the seat guidance information, display the seat guidance information to the staff to guide the user who has visited the restaurant to the seat, wherein
the restaurant has two or more seat groups each having two or more seats,
the seat guidance information is acquired based further on load information relating to a load for operating the restaurant, and
the load information is acquired based on at least one of a quantity of orders of food items, an order frequency, a future usage rate of each of the two or more seat groups, and a number of events requiring involvement of a staff of the restaurant,
when there are two or more seat groups as candidate destinations for guiding a user who has visited the restaurant, the information processing device is further configured to:
calculate scores for the two or more seat groups as the load information, wherein each of the scores indicates a load that is assumed if the user is guided to a corresponding seat group of the two or more seat groups; and
transmit the scores to the display device, and
the display device is further configured to display the scores in association with the two or more seat groups upon receiving the scores.

2. A method for optimally guiding customers to seats, the method, executed by a processor of an information processing device in a restaurant, comprising:
storing usage information in a user information storage unit in association with a user identifier identifying a user, the usage information relating to use of the restaurant by the user and including past usage information relating to consumption behavior by the user in a past usage opportunity;
acquiring, based on the usage information acquired from the user information storage unit, prediction information including a prediction result of the consumption behavior by the user who has visited the restaurant;
acquiring status information indicating a busyness level of the restaurant based at least on a number of users in the restaurant;
acquiring, as support information usable for operation of the restaurant, seat guidance information for guiding the user who has visited the restaurant to a seat in the restaurant based on the prediction information of the user who has visited the restaurant and the status information of the restaurant; and
outputting the seat guidance information to a notification device used for guiding the user who has visited the restaurant to the seat.

3. The method according to claim 2, wherein
the seat guidance information is acquired such that positions of users dining in the restaurant are dispersed when a predetermined time has elapsed.

4. The method according to claim 2, wherein
the restaurant has two or more seat groups each having two or more seats, and
the seat guidance information is acquired such that a particular seat group among the two or more seat groups becomes vacant when a predetermined time has elapsed.

5. The method according to claim 2, wherein
the restaurant has two or more seat groups each having two or more seats,
the seat guidance information is acquired based further on load information relating to a load for operating the restaurant, and
the load information is acquired based on at least one of a quantity of orders of food items, an order frequency, a future usage rate of each of the two or more seat groups, and a number of events requiring involvement of a staff of the restaurant.

6. The method according to claim 5, further comprising
when there are two or more seat groups as candidate destinations for guiding a user who has visited the restaurant, acquiring scores for the two or more seat groups as the load information, wherein
each of the scores indicates a load that is assumed if the user is guided to a corresponding seat group of the two or more seat groups, and
the seat guidance information is acquired such that the user who has visited the restaurant is guided to one of the two or more seat groups having a smallest score of the scores.

7. The method according to claim 6, wherein
the notification device includes a staff notification device that notifies a staff of the restaurant, and
the method further includes outputting the scores to the staff notification device such that the staff notification device notifies the staff of the scores in association with the corresponding two or more seat groups.

8. An information processing device, comprising:
a user information storage unit storing, in association with a user identifier identifying a user, usage information relating to use of a restaurant by the user, the usage information including past usage information relating to consumption behavior by the user in a past usage opportunity;
a prediction unit acquiring prediction information including a prediction result of next consumption behavior by the user based on the usage information acquired from the user information storage unit;
a status information acquisition unit acquiring status information relating to a status in the restaurant;
a support information acquisition unit acquiring, based on the prediction information acquired by the prediction unit for the user who has visited the restaurant and the status information of the restaurant, support information usable for operation of the restaurant; and
a support information output unit outputting the support information.

9. The information processing device according to claim 8, further comprising
a consumption information acquisition unit acquiring consumption information relating to a current consumption behavior by the user who has visited the restaurant, wherein
the consumption information acquisition unit is further configured to accumulate the acquired consumption information as the past usage information in the user information storage unit in association with the user identifier identifying the user.

10. The information processing device according to claim 8, wherein
the usage information includes next usage information that is relating to a planned future use and is input by a user who plans to use the restaurant.

11. The information processing device according to claim 8, wherein
the prediction unit is further configured to acquire the prediction information including a prediction result of the next consumption behavior by a group including two or more users based on the usage information of a user in the group and number-of-persons information of the group.

12. The information processing device according to claim 8, wherein
the prediction unit is further configured to acquire the prediction information including a prediction result of the next consumption behavior by a group including two or more users based on the usage information of each of the two or more users in the group, and
the usage information includes group information relating to the group including the user in a past usage opportunity and past usage information relating to consumption behavior by the group.

13. The information processing device according to claim 8, further comprising
a seat information acquisition unit acquiring seat information including information identifying a seat assigned for a user who has visited the restaurant, wherein
the seat information acquisition unit is further configured to accumulate the acquired seat information in the user information storage unit in association with the user identifier identifying the user.

14. The information processing device according to claim 8, further comprising
a target behavior information acquisition unit acquiring target behavior information relating to a predetermined record target behavior which is a behavior currently conducted by a user who has visited the restaurant and is different from the consumption behavior, wherein
the target behavior information acquisition unit is further configured to accumulate the acquired target behavior information as the usage information in the user information storage unit in association with the user identifier identifying the user.

15. The information processing device according to claim 8, wherein
the prediction unit is further configured to acquire the prediction information including a prediction result of a future consumption behavior by the user during a current usage opportunity based on the usage information relating to past consumption behavior by the user in a past usage opportunity and the usage information relating to past consumption behavior by the user during the current usage opportunity.

16. The information processing device according to claim 8, wherein
the restaurant has two or more seat groups each having two or more seats,
the support information acquisition unit is further configured to:
acquire, based on the prediction information acquired by the prediction unit for the user who has visited the restaurant and the status information of the restaurant, load information relating to a load for operating the restaurant for each of the two or more seat groups; and
acquire the support information based on the load information.

17. The information processing device according to claim 8, wherein
the support information acquisition unit acquires, as the support information, seat guidance information relating to a seat for guiding the user who has visited the restaurant.

18. The information processing device according to claim 17, wherein
the support information output unit is configured to cause an output device corresponding to the seat for guiding the user who has visited the restaurant to output information indicating a number of users in a group including the user.

19. The information processing device according to claim 8, further comprising
a future status information acquisition unit acquiring, using the prediction information acquired for users currently using the restaurant and the prediction information acquired for users who will use the restaurant in the future, future status information relating to a future status in the restaurant; and
a future status information output unit outputting the future status information such that a staff of the restaurant can confirm the future status information.

20. A non-transitory, computer readable storage medium storing a program for a processor of a computer, which is configured to access a user information storage unit that stores, in association with a user identifier identifying a user, usage information relating to use of a restaurant by the user, the usage information including past usage information relating to consumption behavior by the user in a past usage opportunity, the program, when executed by the processor, causing the processor to:
acquire the usage information of the user from the user information storage unit;
acquire, based on the usage information, prediction information including a prediction result of the next consumption behavior by the user; and
output the prediction information.
.
